(19) United States
(12) Patent Application Publication
(10) Pub. No.: US 2026/0129489 A1
(43) Pub. Date: May 7, 2026

(54) DATA COLLECTION FOR ARTIFICIAL INTELLIGENCE FUNCTIONALITIES

(71) Applicant: Lenovo (United States) Inc., Morrisville, NC (US)

(72) Inventors: Tapisha Soni, Munich (DE); Vahid Pourahmadi, München (DE); Joachim Löhr, Wiesbaden (DE)

(73) Assignee: Lenovo (United States) Inc., Morrisville, NC (US)

(21) Appl. No.: 18/940,217

(22) Filed: Nov. 7, 2024

(51) Int. Cl. H04W 24/10; H04W 76/27

(52) U.S. Cl. CPC H04W 24/10; H04W 76/27

(57) ABSTRACT

Various aspects of the present disclosure relate to data collection for artificial intelligence (AI) functionalities. An apparatus, such as a UE, transmits first signaling that requests a configuration for collection of data for one or more AI functionalities. The UE receives, responsive to the first signaling, second signaling that indicates the configuration for the collection of the data. The UE then collects the data on the configuration. In some examples, a training entity transmits signaling that requests the data associated with one or more AI functionalities. The UE transmits, responsive to the signaling, signaling that approves collection of the data or rejects the collection of the data based on a configuration for the collection of the data.

### TECHNICAL FIELD

The present disclosure relates to wireless communications, and more specifically to enabling (e.g., determining, identifying, applying, activating, executing, configuring) one or more artificial intelligence (AI) functionalities.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit first signaling that requests a configuration for collection of data for one or more AI functionalities; receive, responsive to (or based at least in part on) the first signaling, second signaling that indicates the configuration for the collection of the data; and collect the data based on the configuration.

A processor for wireless communication is described. The processor may be configured to, capable of, or operable to perform one or more operations as described herein. For example, the processor may be configured to, capable of, or operable to transmit first signaling that requests a configuration for collection of data for one or more AI functionalities; receive, responsive to (or based at least in part on) the first signaling, second signaling that indicates the configuration for the collection of the data; and collect the data based on the configuration.

A method performed or performable by a UE for wireless communication is described. The method may include transmitting first signaling that requests a configuration for collection of data for one or more AI functionalities; receiving, responsive to (or based at least in part on) the first signaling, second signaling that indicates the configuration for the collection of the data; and collecting the data based on the configuration.

In some implementations of the UE, the processor, and the method described herein, the configuration includes respective sets of parameters corresponding to the one or more AI functionalities. In some implementations of the UE, the processor, and the method described herein, the one or more AI functionalities are performed or performable by (or one or more of stored at, supported by, or configured for) the UE.

Some implementations of the UE, the processor, and the method described herein, the UE, the processor, and the method may further be configured to, capable of, operable to perform a handshake procedure with an NE prior to collection of the data.

Some implementations of the UE, the processor, and the method described herein, the UE, the processor, and the method may further be configured to, capable of, operable to transmit third signaling that indicates information corresponding to a set of AI functionalities supported by the UE. In some implementations of the UE, the processor, and the method described herein, the set of AI functionalities includes the one or more AI functionalities. In some implementations of the UE, the processor, and the method described herein, the UE, the processor, and the method may further be configured to, capable of, operable to receive fourth signaling that indicates respective information related to one or more parameters corresponding to the one or more AI functionalities at the UE. In some implementations of the UE, the processor, and the method described herein, the respective information related to the one or more parameters includes at least one of a set of parameters or a time-frequency configuration for the one or more parameters.

In some implementations of the UE, the processor, and the method described herein, the first signaling indicates one or more of the one or more AI functionalities performed or performable by (or one or more of stored at, supported by, or configured for) the UE, an identifier (ID) of the one or more AI functionalities performed or performable by (or one or more of stored at, supported by, or configured for) the UE, a respective set of parameters corresponding to the one or more AI functionalities performed or performable by (or one or more of stored at, supported by, or configured for) the UE, or an ID of the respective set of parameters corresponding to the one or more AI functionalities performed or performable by (or one or more of stored at, supported by, or configured for) the UE.

Some implementations of the UE, the processor, and the method described herein, the UE, the processor, and the method may further be configured to, capable of, operable to receive, prior to the first signaling, third signaling that indicates a set of configurations for collection of respective data for a set of AI functionalities. In some implementations of the UE, the processor, and the method described herein, the set of configurations includes the configuration. In some implementations of the UE, the processor, and the method described herein, the first signaling requests activation of the configuration. In some implementations of the UE, the processor, and the method described herein, the second signaling activates the configuration.

In some implementations of the UE, the processor, and the method described herein, the one or more AI functionalities performed or performable by (or one or more of stored at, supported by, or configured for) the UE include one or more of a beam management procedure, a channel state information (CSI) prediction procedure, a measurement prediction, or a radio link failure (RLF) prediction.

Some implementations of the UE, the processor, and the method described herein, the UE, the processor, and the method may further be configured to, capable of, operable to receive third signaling that indicates associated IDs corresponding to one or more network conditions.

Some implementations of the UE, the processor, and the method described herein, the UE, the processor, and the method may further be configured to, capable of, operable to transmit third signaling that accepts the collection of the data or rejects the collection of the data.

Some implementations of the UE, the processor, and the method described herein, the UE, the processor, and the method may further be configured to, capable of, operable to transmit third signaling that indicates information for initiating or terminating data collection or indicates assistance information for the data collection.

Some implementations of the UE, the processor, and the method described herein, the UE, the processor, and the method may further be configured to, capable of, operable to receive third signaling that requests the data. In some implementations of the UE, the processor, and the method described herein, the third signaling indicates a periodicity for collecting the data.

Some implementations of the UE, the processor, and the method described herein, the UE, the processor, and the method may further be configured to, capable of, operable to transmit at least one of a status report or a scheduling request (SR) that indicates at least one of a presence of the data in a buffer associated with the UE, an availability of the data, an amount of the data in the buffer, a priority level associated with the data, or an ID associated with the one or more AI functionalities.

In some implementations of the UE, the processor, and the method described herein, the first signaling includes a request for at least one of a measurement configuration associated with the data, a logging configuration associated with the data, or a reporting configuration associated with the data.

In some implementations of the UE, the processor, and the method described herein, the configuration includes the at least one of the measurement configuration associated with the data, the logging configuration associated with the data, or the reporting configuration associated with the data.

In some implementations of the UE, the processor, and the method described herein, the configuration includes one or more of measurement quantities associated with the data, time-frequency resources associated with the collection of the data, or metrics associated with the one or more AI functionalities.

In some implementations of the UE, the processor, and the method described herein, the first signaling includes radio resource control (RRC) signaling.

An NE for wireless communication is described. The NE may be configured to, capable of, or operable to perform one or more operations as described herein. For example, the NE may be configured to, capable of, or operable to receive, from a UE, first signaling that requests a configuration for collection of data associated with one or more AI functionalities, and transmit, responsive to the first signaling, second signaling that indicates the configuration for the collection of the data.

A processor for wireless communication is described. The processor may be configured to, capable of, or operable to perform one or more operations as described herein. For example, the processor may be configured to, capable of, or operable to receive, from a UE, first signaling that requests a configuration for collection of data associated with one or more AI functionalities, and transmit, responsive to the first signaling, second signaling that indicates the configuration for the collection of the data.

A method performed or performable by an NE for wireless communication is described. The method may include receiving, from a UE, first signaling that requests a configuration for collection of data associated with one or more AI functionalities, and transmitting, responsive to the first signaling, second signaling that indicates the configuration for the collection of the data.

In some implementations of the NE, the processor, and the method described herein, the configuration includes respective sets of parameters corresponding to the one or more AI functionalities at the UE. In some implementations of the NE, the processor, and the method described herein, the NE, the processor, and the method may further be configured to, capable of, operable to receive third signaling that indicates information corresponding to a set of AI functionalities performed or performable by (or one or more of stored at, supported by, or configured for) the UE. In some implementations of the NE, the processor, and the method described herein, the set of AI functionalities includes the one or more AI functionalities. In some implementations of the NE, the processor, and the method described herein, the NE, the processor, and the method may further be configured to, capable of, operable to transmit fourth signaling that indicates respective information related to one or more parameters corresponding to the one or more AI functionalities. In some implementations of the NE, the processor, and the method described herein, the respective information related to the one or more parameters includes at least one of a list of parameters or a time-frequency configuration for the one or more parameters. In some implementations of the NE, the processor, and the method described herein, the first signaling indicates one or more of the one or more AI functionalities performed or performable by the UE, an ID of the one or more AI functionalities performed or performable by the UE, a respective set of parameters corresponding to the one or more AI functionalities performed or performable by the UE, or an ID of the respective set of parameters corresponding to the one or more AI functionalities performed or performable by the UE. In some implementations of the NE, the processor, and the method described herein, the NE, the processor, and the method may further be configured to, capable of, operable to transmit, prior to receiving the first signaling, third signaling that indicates a set of configurations for collection of respective data for a set of AI functionalities. In some implementations of the NE, the processor, and the method described herein, the set of configurations includes the configuration, the first signaling requests activation of the configuration, and the second signaling activates the configuration. In some implementations of the NE, the processor, and the method described herein, the NE, the processor, and the method may further be configured to, capable of, operable to transmit third signaling that accepts the collection of the data or rejects the collection of the data. In some implementations of the NE, the processor, and the method described herein, the NE, the processor, and the method may further be configured to, capable of, operable to transmit third signaling that indicates associated IDs corresponding to one or more network conditions.

In some implementations of the NE, the processor, and the method described herein, the NE, the processor, and the method may further be configured to, capable of, operable to receive at least one of a status report or a SR that indicates at least one of a presence of the data in a buffer associated with the UE, an availability of the data, an amount of the data in the buffer, a priority level associated with the data, or an ID associated with the one or more AI functionalities. In some implementations of the NE, the processor, and the method described herein, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. In some implementations of the NE, the processor, and the method described herein, the configuration includes one or more of measurement quantities associated with the data, time-frequency resources associated with the collection of the data, or metrics associated with the one or more AI functionalities. In some implementations of the NE, the processor, and the method described herein, the NE includes a base station or a location management function (LMF). Additionally, or alternatively, the first signaling includes RRC signaling.

An NE for wireless communication is described. The NE may be configured to, capable of, or operable to perform one or more operations as described herein. For example, the NE may be configured to, capable of, or operable to transmit first signaling that requests data associated with one or more AI functionalities, and receive, responsive to the first signaling, second signaling that approves collection of the data or rejects the collection of the data based on a configuration for the collection of the data.

A processor for wireless communication is described. The processor may be configured to, capable of, or operable to perform one or more operations as described herein. For example, the processor may be configured to, capable of, or operable to transmit first signaling that requests data associated with one or more AI functionalities, and receive, responsive to the first signaling, second signaling that approves collection of the data or rejects the collection of the data based on a configuration for the collection of the data.

A method performed or performable by an NE for wireless communication is described. The method may include transmitting first signaling that requests data associated with one or more AI functionalities, and receiving, responsive to the first signaling, second signaling that approves collection of the data or rejects the collection of the data based on a configuration for the collection of the data

In some implementations of the NE, the processor, and the method described herein, the first signaling is transmitted to at least one of a UE or an additional NE. In some implementations of the NE, the processor, and the method described herein, the configuration includes respective sets of parameters corresponding to the one or more AI functionalities, where the one or more AI functionalities are performed or performable by (or one or more of stored at, supported by, or configured for) a UE. In some implementations of the NE, the processor, and the method described herein, the one or more AI functionalities includes one or more of a beam management procedure, a CSI prediction procedure, a measurement prediction, or an RLF prediction. In some implementations of the NE, the processor, and the method described herein, the first signaling indicates a periodicity for collecting the data. Additionally, or alternatively, the NE includes an operation, administration, and maintenance (OAM) entity, a core network (CN), or an over-the-top (OTT) server.

### BRIEF DESCRIPTION OF THE DRAWINGS

FIGS. 1 and 2 illustrate examples of wireless communications systems, in accordance with aspects of the present disclosure.

FIG. 3 illustrates an example AI functionality diagram, in accordance with aspects of the present disclosure.

FIGS. 4 through 6 illustrate example signaling diagrams, in accordance with aspects of the present disclosure.

FIG. 7 illustrates an example network diagram, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a NE in accordance with aspects of the present disclosure.

FIG. 11 illustrates a flowchart of a method performed by a UE in accordance with aspects of the present disclosure.

FIGS. 12 and 13 illustrate flowcharts of methods performed by NEs in accordance with aspects of the present disclosure.

### DETAILED DESCRIPTION

In a wireless communications system, a UE and a NE (e.g., a base station, gNB) may support one or more AI and/or machine learning (ML) functionalities to perform wireless communication (e.g., reception and/or transmission of signaling). For example, the UE and the NE may implement AI functionalities for CSI feedback compression, modulation, demodulation, scheduling, interference management, and positioning, among other examples, to reduce overhead, improve performance, or reduce latency for the wireless communication. The AI functionalities may represent different use cases for AI and/or ML models. The NE may support (e.g., use, apply) the AI and/or ML models trained (e.g., updated, fine-tuned, monitored) for the different AI functionalities using data collected from an environment of the UE and/or the NE. Some data collection techniques are designed to improve performance of the models at the NE and may not be applicable for models implemented at the UE. The performance (e.g., accuracy, UE may benefit from implementing models trained using data collected by the UE with respect to defined AI functionalities, such as beam management (e.g., temporal domain beam management and spatial domain beam management), CSI prediction, measurement prediction, and RLF prediction, among other examples. However, the UE may not be configured to collect the data for training the models. Additionally, or alternatively, the data and/or AI functionalities of the models may be proprietary (e.g., private) to the UE, and therefore not accessible by the NE.

As described herein, the UE may transmit a request for a configuration for collecting data for the AI functionalities to a NE. The NE may transmit the configuration to the UE. Additionally, or alternatively, the NE may transmit signaling that indicates a set of configurations for collecting the data for the AI functionalities, and a UE may activate at least one of the configurations. The UE may collect the data using the configuration. The configuration may indicate one or more of measurement quantities for the data, time-frequency resources to use for collecting the data, or metrics of the one or more AI functionalities. In some examples, a training entity may indicate for the UE to transmit the request for the configuration, and the UE may report whether the data collection is accepted or rejected upon (or based at least in part on) receiving or activating a configuration from the NE.

By performing the described techniques, a UE in a wireless communications system can use a configuration to collect data for AI functionalities. This approach may enable more efficient and flexible data collection compared to some solutions, as the UE can request and receive specific configurations tailored to (e.g., adapted to, configured for) the AI functionalities. The configurable nature of the data collection process may provide for dynamic adaptation to different network conditions and AI functionalities. Additionally, or alternatively, the ability to accept (e.g., approve) or reject data collection requests and indicate parameters, such as measurement quantities and time-frequency resources, may provide enhanced control and privacy protection for UEs, while supporting the development and optimization of AI network features.

Reference is made herein to communicating data or information, such as signaling configurations that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

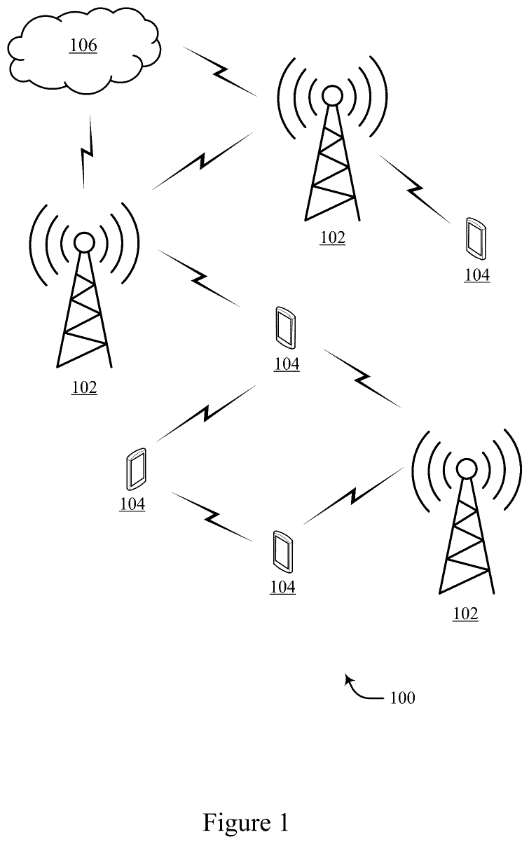

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communications link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communications link. For example, a UE 104 may support wireless communication directly with another UE 104 over a device-to-device (D2D) communications link. In some implementations, such as vehicle-to-vehicle (V2V) deployments, vehicle-to-everything (V2X) deployments, or cellular-V2X deployments, the communications link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 may support (e.g., use, apply, deploy) one or more models (e.g., ML models and/or AI models) for wireless communications to reduce overhead, improve performance, or reduce latency for wireless communications. For example, a UE 104 and/or a NE 102 may implement the one or more models for CSI feedback compression, modulation, demodulation, scheduling, interference management, and positioning. The different use cases for the models may be referred to as functionalities, AI functionalities, or AI/ML functionalities. Different devices may support different AI functionalities. For example, a UE 104 may support different AI functionalities than a NE 102. In some other examples, the UE 104 may support the same functionalities as the NE 102. Thus, the procedures for implementing the models and the models themselves may be use-case (e.g., AI functionality) dependent. However, training (e.g., updating, fine-tuning, monitoring) of the models may depend on data collected from the environment of the devices, as well as one or more conditions or scenarios experienced by the involved entities and devices.

For example, a NE 102 and/or other device (e.g., a UE 104) in the wireless communications system 100 may train models for various AI functionalities using data that is collected for respective AI functionalities. The type of data that the devices collect may be AI functionality dependent. Data collected for beam management may include signal strength measurements, angle of arrival (AoA) information, and spatial channel characteristics, while data for CSI prediction may include time-varying channel coefficients and multipath parameters. The training process may involve iterative refinement of the models using collected data, such as by using federated learning to preserve data privacy. The models may be continuously updated as new data is collected, providing for adaptive learning that accounts for changing network conditions and user behaviors. By utilizing different data for respective AI functionalities (e.g., data dependent on an AI functionality) during a training process, the NEs 102 and/or UEs 104 may improve an accuracy and efficiency of the models for performing AI tasks, which may also enhance overall network performance and user experience. The AI tasks may include, but are not limited to, beam prediction, channel estimation, or RLF prediction.

In some examples, one or more devices in the wireless communications system 100 may implement minimization of drive tests (MDT) framework for data collection from the environment of the devices. The MDT framework may enhance a performance of networks and may improve user experience by improving the process of network measurement and data collection. For example, the MDT framework minimizes drive tests, which may be used to collect data for improvement of network performance and network troubleshooting. Drive tests involve sending one or more users to physically drive around in vehicles equipped with measurement equipment to gather network performance data, which can be costly and time-consuming.

In some examples, the devices may implement one or more different MDT frameworks, including an immediate MDT framework and/or a logged MDT framework. An immediate MDT framework focuses on real-time data collection from a UE 104 configured by a NE 102 or triggered by defined events or conditions. The immediate MDT framework is applicable to UEs 104 in an RRC_CONNECTED state. The immediate MDT framework involves the UE 104 reporting various network measurements to the network in real time (e.g., instantly) when a defined trigger occurs, such as thresholds for signal strength or quality being met. The data reported includes critical performance indicators, such as reference signal received power (RSRP), reference signal received quality (RSRQ), and other relevant metrics that indicate a current state (e.g., condition, status) of the network. The other metrics may include, but are not limited to, a signal-to-interference-plus-noise ratio (SINR), a channel quality indicator (CQI), a block error rate (BLER) that indicates a proportion of data blocks received with errors, throughput measurements that indicate actual data transfer rates experienced by UEs 104, latency metrics that indicate a delay in data transmission, cell load indicators that indicate a current utilization of network resources, and handover success rates, among other examples. The immediate reporting capability may be used for diagnostics, enabling network operators to efficiently identify and address issues, such as coverage gaps, interference problems, or unexpected drops in service quality. The immediate MDT framework may be used for a relatively quick resolution (e.g., less than a threshold duration), such as during network outages or when updating (e.g., optimizing) handovers in dense urban environments due to providing real-time network data. Thus, the immediate MDT framework enhances a capacity for proactive network management, contributing to improved user experience and more robust network operations.

A logged MDT framework is designed to enhance network performance monitoring by providing for a UE 104 to collect and log network performance data over time when the UE 104 is operating in a state without an RRC connection (e.g., RRC_IDLE) or without a data connection (e.g., RRC_INACTIVE). The logged MDT framework enables UEs 104 to record (e.g., store) various measurements when in an RRC_IDLE state or an RRC_INACTIVE state and report the measurements at a later time (e.g., by switching to the RRC_CONNECTED state), such as when the device is idle or connected to a non-cellular network. The logged MDT framework provides a comprehensive dataset without increasing signaling overhead or impacting user experience. A NE 102 may configure the UE 104 for the logged MDT framework by indicating one or more parameters to be measured, the conditions under which the measurements are to be taken, and the logging duration. The collected data includes critical network performance metrics, such as signal strength (e.g., RSRP), signal quality (e.g., RSRQ), throughput, and location information, which can be based on global positioning system (GPS) data or a cell-ID. The data is stored in memory of the UE 104 and periodically updated as the UE 104 moves through different areas and experiences varied network conditions. Once the logging period is complete or when defined conditions for data reporting are met, the UE 104 sends the logged data to the network.

For both the immediate MDT framework and the logged MDT framework, there is data collection and reporting. The NE 102 may transmit an MDT configuration message to one or more UEs 104. The MDT configuration message may include detailed instructions that indicate to the UEs 104 what to measure, when to measure and report, and how and when to report. For example, the MDT configuration message identifies the parameters the UEs 104 are to monitor (e.g., signal strength, quality, handover events). Additionally, or alternatively, the MDT configuration message indicates timing and conditions for the measurements (e.g., periodically, event-triggered, or based on a location). Additionally, or alternatively, the MDT configuration message indicates a format, frequency, and/or destination for sending the collected data back to the NE 102.

The NE 102 may transmit the MDT configuration message in an information element (IE) (e.g., IE MeasConfig) as part of another message, such as an RRCReconfiguration or RRCResume message to configure the immediate MDT framework. The NE 102 may also transmit one or more parameters, such as a measObjectToAddModList parameter and/or a measObjectToRemoveList parameter, which includes a list of measurement objects to add, modify, and/or remove. A measurement object configuration is identified by a measurement object identity. The measurement object, MeasObject, may define what the UE 104 is to measure (e.g., a carrier frequency or other time-frequency resource). The parameters may include a reportConfigToAddModList and/or a reportConfigToRemoveList parameter, which indicate a list of measurement reporting configurations to add, modify, and remove. A measurement reporting configuration is identified by a measurement reporting configuration identity. Each measurement reporting configuration specifies a reporting triggering criterion, a reference signal type, a reporting format, and a reporting type. The reporting type can be of event triggered reporting, periodic reporting, cell global ID (CGI) reporting, or system frame number (SFN) time difference (SFTD) reporting. The parameters may include a measIdToAddModList parameter and a measIdToRemoveList parameter, which indicate a list of measurement identities to add, modify, and remove. Each measurement configuration is identified by a measurement identity and links one measurement object configuration with a measurement reporting configuration. By configuring multiple measurement identities, more than one measurement object may be linked to a same reporting configuration and/or more than one reporting configuration may be linked to a same measurement object.

For the logged MDT framework, the UE 104 can be configured to start logging using a LoggedMeasurementConfiguration message. The reporting and/or logging may be threshold-based. For example, the NE 102 may configure thresholds for different CSI-reference signal (CSI-RS) based metrics, and the UE 104 may use the thresholds to determine when to report and/or log the data. The CSI-RS based metrics may include, but are not limited to, an RSRP, an RSRQ, and a SINR. An RSRP is a power of the CSI-RS received by the UE 104. An RSRQ is a quality of the CSI-RS received by the UE 104, taking into account both signal strength and interference. A SINR is a ratio of the desired signal power to the interfering and noise power in the CSI-RS. Additionally, or alternatively, the reporting and/or logging may be time-based. For example, the NE 102 may configure a logging interval and a duration for the UE 104 to use for logging and/or reporting the data. A logging interval may define an interval in time at which the UE 104 logs the measurement data, typically in milliseconds (ms) or seconds (e.g., every 120 ms). The duration is a total duration for which the reporting is active (e.g., over a period of 10 minutes).

Additionally, or alternatively, the reporting and/or logging may be location-based. For example, the NE 102 may configure area-based reporting, such that data collection can be triggered when the UE 104 enters or exits defined cell IDs or an area defined by a parameter, areaConfiguration. The NE may configure spatial relation based reporting (SFTD), which leverages spatial relations between the UE 104 and reference points. The reference points may be beams (e.g., defined by beam reference signals) or cell identities. The reporting of the data can be triggered based on events, such as entering or leaving a defined beam (e.g., SFTD-enter, SFTD-leave), a distance to a beam exceeding a threshold (e.g., SFTD-distance), or a distance to a cell exceeding a threshold.

In some examples, the measurement and reporting of the data may be event triggered. The events are defined conditions, such as changes in signal strength or quality, that trigger data collection. The UE 104 starts gathering data when the event occurs. The events can include, but are not limited to, a serving cell becomes better than a threshold, a serving cell becoming worse than a threshold, a neighbor becoming an amount of offset better than a primary cell (PCell) or a primary secondary cell (PSCell), a neighbor cell becoming better than a threshold, a PCell or a PSCell becoming worse than an absolute threshold and a neighbor or secondary cell (SCell) becoming better than another absolute threshold, a neighbor becoming an amount of offset better than a SCell, an inter-RAT neighbor cell becomes better than a threshold, and/or a PCell becoming worse than an absolute threshold and a neighbor becoming better than another absolute threshold. For an event-based reporting a configuration, triggerConfig, defines one or more conditions that trigger a measurement report. The configuration includes one or more parameters, such as triggerType (e.g., defines a type of trigger), event (e.g., report when a specific event occurs, including crossing a signal strength threshold or entering a new cell), periodic (e.g., report at regular intervals), onDemand (e.g., report upon explicit request from the network), eventId (e.g., for event triggers, includes a defined event ID), triggerQuantity (e.g., for event triggers, includes the measurement quantity to be monitored for the event), thresholds and offsets (e.g., the threshold values and offset used for triggering the report), hysteresis (e.g., a margin to prevent frequent triggering near the threshold), timeToTrigger (e.g., for event triggers, includes the time duration to wait after the event condition is met before triggering the report), reportInterval (e.g., for periodic triggers, includes the time interval between reports), reportAmount (e.g., for periodic triggers, includes the number of reports to send after a trigger), and/or reportOnLeave (e.g., indicates whether or not the UE 104 is to initiate the reporting procedure when the leaving condition is met).

In an MDT framework (e.g., an immediate MDT framework or a logged MDT framework), instead of a designated test equipment, a UE 104 can be configured to measure various network performance indicators, such as signal strength, quality, and coverage. The data collected by the UE 104 can then be used by network operators to assess and improve network performance. The MDT framework is designed to collect data both in real-time and over relatively long periods (e.g., greater than a threshold duration), with the measurements being triggered by network events or collected periodically during regular device usage. The different modes of data collection method enables operators to gather a comprehensive understanding of network conditions without deploying extensive field-testing resources.

The MDT framework involves UEs 104 being configured by the network to collect defined measurement data, which can include parameters like reference signal received power (RSRP), reference signal received quality (RSRQ), and other network performance metrics. The UE 104 either reports the data upon collection when one or more defined conditions are met or logs the data for transmission at a later time (e.g., when a delay does not impact user experience). This flexible data collection method ensures continuous monitoring of network performance, providing for operators to quickly identify and resolve issues, improve resource allocation, and enhance overall service quality. The MDT framework leverages the widespread availability of UEs 104 to provide a cost-effective and efficient way to maintain and improve mobile network performance.

For gNB-centric and OAM-centric (e.g., for RRC signaling between a UE 104 and gNB) data collection, reporting multiple instances of logged layer 1 (L1) measurement results from a UE 104 to gNB via an RRC message as configured by the gNB is an optional feature. The MDT framework is a baseline framework for OAM-centric data collection for the training of a network-sided model (e.g., a model implemented for AI functionalities at the NE 102). An enhance MDT framework may support periodical reporting of collected data. Data collection initiation and configuration for data collection is under network control. One or more UEs 104 may implement different MDT frameworks for different RRC modes (e.g., states). For example, the UE 104 may implement different MDT frameworks for an RRC connected state and an RRC idle or inactive state. The MDT framework for RRC-connected UEs 104 does not offer a solution for logging measurements, as the UEs 104 perform and report the measurements in real-time (e.g., instantaneously). The MDT framework for RRC idle or inactive UEs 104 provides for logging measurements for a period based on a single measurement configuration at a time. Therefore, the devices in the wireless communications system 100 may not reuse the MDT framework for data collection for AI functionalities. Instead, the wireless communications system 100 may extend the MDT framework to enable flexibility in data collection considering factors relevant to AI and/or ML lifecycle management (LCM) function. The MDT framework accounts for network performance improvement, and a scope of the MDT framework is not directly applicable to UE-sided AI functionalities (e.g., AI/ML features).

For models implemented (e.g., applied, executed) at the UE 104 (e.g., UE-sided AI/ML models), a UE 104 may measure (e.g., collect, obtain) data for one or more LCM functions, including training and monitoring. The UE 104 may collect the data with respect to different AI functionalities at the UE 104 (e.g., specific AI/ML use-cases or sub use-cases). The AI functionalities may include, but are not limited to, beam management (e.g., temporal domain beam management and spatial domain beam management), CSI prediction, measurement prediction, and RLF prediction, among other examples. In some cases, the data collection for implementing UE-sided models may differ based on an entity that trains the UE-sided models and a first termination entity of the data. Thus, data collection may involve entities such as an OAM, a CN 106, and/or UE-side OTT servers. The UE 104 may use a configuration, as well as additional information and/or assistance information, from a NE 102 to collect data for AI functionalities (e.g., AI/ML training and monitoring for models used to implement the AI functionalities).

The NE 102 may manage a measurement reporting scheme for the UE 104, such that the network may control and configure reporting of logged measurements at the UE 104. However, for UE-sided models, network control reporting of logged measurements may compromise data security for proprietary (e.g., private) information of the UE 104. Thus, the NE 102 may exchange information (e.g., assistance information) with the UE 104 to manage the operations at the UE 104 and the NE 102, such as radio resource management.

Some wireless communications systems may lack efficient mechanisms for collecting data to support AI functionalities at UEs 104. For example, the wireless communications systems may use static or predefined data collection methods that fail to account for the diverse and evolving AI capabilities of different UEs. Using static and/or predefined data can result in inefficient use of network resources, reduced AI performance, and privacy breaches for UEs 104. Additionally, or alternatively, the wireless communications systems may not provide flexibility for UEs 104 to train models for UE-sided functionality (e.g., by requesting data collection configurations for one or more AI functionalities), leading to reduced network performance and user experience.

According to implementations, one or more of the NEs 102 and the UEs 104 are operable to implement various aspects of the techniques described with reference to the present disclosure. For example, a UE 104 and one or more NEs 102 may implement a dynamic and configurable approach to data collection for AI functionalities in the wireless communications system 100. A UE 104 may request and receive customized configurations for data collection, providing for more efficient and targeted gathering of information to support various AI functionalities. The wireless communications system 100 provides a flexible framework, in which UEs 104 indicate AI capabilities, request specific parameters, and approve or reject data collection requests. NEs 102 can respond with configurations to assist the data collection at the UE 104 or UE-side, including measurement quantities, time-frequency resources, and other relevant parameters for AI functionalities (e.g., AI functionalities at the UE).

Reference is made herein to communicating data or information, such as signaling configurations for collection of data that are transmitted or received between devices. It is to be appreciated that other terms may be used interchangeably with communicating, such as signaling, transmitting, receiving, outputting, forwarding, retrieving, obtaining, and so forth.

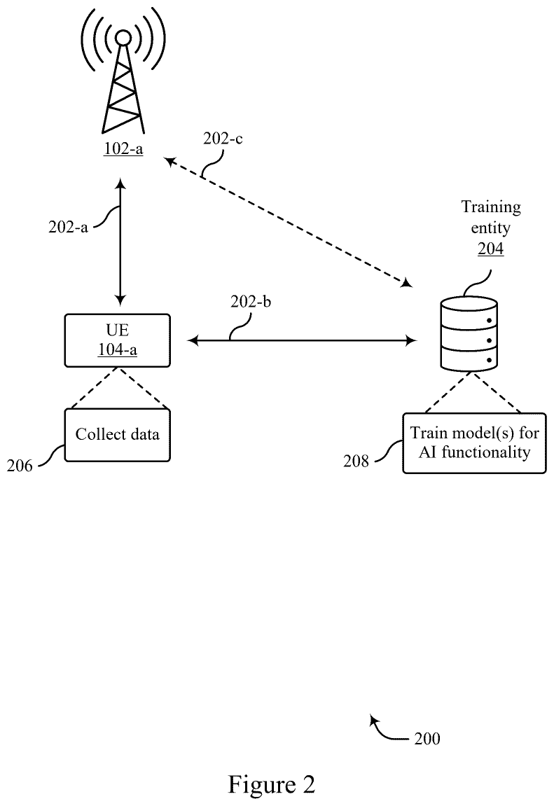

FIG. 2 illustrates an example wireless communications system 200 in accordance with aspects of the present disclosure. In some examples, the wireless communications system 200 implements or is implemented by aspects of the wireless communications system 100. For example, the wireless communications system 200 may include a UE 104-a and a NE 102-a, which may be examples of the corresponding devices as described with reference to FIG. 1. The UE 104-a may communicate with the NE 102-a via a communications link 202-a, and the UE 104-a may communicate with a training entity 204 via a communications link 202-b. For example, the UE 104-a may receive a request for data for one or more AI functionalities from the training entity 204 via the communications link 202-b and may exchange signaling with the NE 102-a via the communications link 202-a to coordinate collection of the data. In some examples, the NE 102-a may optionally communicate with the training entity 204 via a communications link 202-c.

A training entity 204 may be a device, system, entity and/or server responsible for collecting, processing, and utilizing data to train AI models for various functionalities in the wireless communications system 200. The training entity 204 may be implemented in or by different types of devices, such as OTT servers, other servers, CNs, OAMs, and/or dedicated AI processing units within network infrastructure. For example, an OAM may act as a training entity 204 by aggregating data from multiple UEs and performing local model updates. Additionally, or alternatively, a centralized server in a CN may serve as a training entity, collecting data from numerous NEs and UEs across a wide geographic area. In some cases, a UE (e.g., the UE 104-a) may function as a training entity by performing on-device learning for AI models or may access trained models from an OTT server or UE-side server that functions as a training entity 204. A training entity 204 may interface with UEs directly or indirectly through standard wireless communication protocols (e.g., with the UE 104-a via the communications link 202-b), such as by using dedicated signaling for AI-related data collection and model distribution. The interface between a training entity 204 and a NE 102-a, such as the communications link 202-c, may include a backhaul connection, such as if the training entity 204 is implemented by an OAM, a CN, or another NE, providing for efficient transfer of large datasets and updated model parameters. In some cases, a hierarchical structure of training entities may be employed, with local entities performing initial data processing and model updates, while higher-level entities coordinate global model distribution.

The training entity 204 may establish a connection with the UE 104-a. The UE 104-a may indicate one or more supported and/or requested AI functionalities to the training entity 204. For example, the UE 104-a may transmit signaling to the training entity 204 via the communications link 202-b that requests one or more models for a beam management AI functionality, a CSI prediction AI functionality, an RLF prediction AI functionality, or any other AI functionality implemented at a UE. The training entity 204 may be configured to train the models for the AI functionality and to provide the trained models to the UE 104-a to implement the AI functionality (e.g., perform the beam management, CSI prediction, and/or RLF prediction using output from the models). Training the models may include collecting data from the UE 104-a to initialize one or more parameters of the models or to update one or more model parameters for a defined AI functionality (e.g., use-case), which may provide for improved performance of the models for the AI functionality, including accuracy and precision among other performance metrics.

The training entity 204 may transmit a request for the UE 104-a to collect data for one or more AI functionalities via the communications link 202-b. The UE 104-a may coordinate with the NE 102-a to obtain (e.g., receive, activate) a configuration for collecting the data. For example, the NE 102-a may configure the UE 104-a to perform measurements by providing a data collection configuration to the UE 104-a. The data collection configuration may include a measurement configuration, a logging configuration, and/or a reporting configuration for measuring, logging, and reporting collected data. Based on the network configuration, the UE 104-a performs measurements that may be used for radio connection purposes, as well as for MDT or AI/ML type of data collection purposes.

For AI/ML-related purposes (e.g., for UE-sided AI/ML LCM), the UE 104-a and/or UE-side may collect data according to a configuration that is based on existing signaling and/or new signaling. In some cases, the AI/ML data collection can be performed by reusing a measurement configuration provided by the NE 102-a. For example, the data and/or measurements collected in accordance with the measurement configuration can be logged or reported differently for AI/ML purposes. Thus, the UE 104-a may apply a separate logging and reporting configuration depending on the type of entity collecting the data for the UE-sided model LCM. The UE 104-a may measure and/or log the data without a new network configuration for AI/ML data collection. However, for reporting the logged data the UE 104-a may use some support, assistance, or approval from the NE 102-a when the reporting is performed via one or more different networks. The NE 102-a may manage the radio resources for transmission of the AI/ML-related data, such that the transmission does not impact other services offered by the NE 102-a or the UE 104-a operation (e.g., other services). In some examples, the network may assign defined preferences and/or priorities while scheduling data related to AI/ML data collection. The UE 104-a may indicate additional information while sending an SR to the NE 102-a. The NE 102-a may use the information to schedule uplink resources efficiently by accounting for a QoS (e.g., latency) criterion (e.g., requirement) for the data to be transmitted or for one or more services. For example, the UE 104-a may transmit a new data collection buffer status report (BSR) and/or a new SR for UE-sided data collection that is used to indicate the presence of AI/ML-related data for UE-sided LCM.

In some other cases, the NE 102-a may transmit a separate and/or additional measurement configuration, such as for AI/ML data collection. For example, the NE 102-a may transmit a separate measurement configuration if the AI/ML data collection criterion (e.g., requirements of parameters to be measured or collected) are beyond the scope of an existing measurement configuration provided by the NE 102-a, such that the data or parameters to be measured or collected are not part of the existing configuration. Additionally, or alternatively, the NE 102-a may transmit an update to an existing measurement configuration to fulfill one or more criterion (e.g., requirements) of the UE-sided AI/ML LCM. The UE 104-a may measure more or different data than the data configured by the existing measurement configuration. If the UE 104-a does not obtain a configuration (e.g., new or updated) to collect the relevant data for UE-sided AI/ML training, then the UE may perform one or more of the following processes. The UE 104-a may perform the data collection according to the existing measurement configuration. Additionally, or alternatively, the UE 104-a may not perform any other measurements other than the measurements configured as part of the existing measurement configuration provided by the NE 102-a. Additionally, or alternatively, the UE 104-a may request a new data collection configuration from the NE 102-a. Additionally, or alternatively, the UE 104-a may send a data collection request to the NE 102-a, and may receive a separate (e.g., different, additional, new, updated) measurement configuration from the NE 102-a, where the separate measurement configuration is for AI/ML data collection. The separate measurement configuration may not overwrite the existing measurement configuration applied at the UE 104-a. Thus the UE may perform measurements according to the existing measurement configuration for radio connection purposes and may additionally perform one or more additional measurements according to a new measurement configuration for AI/ML data collection purposes. Additionally, or alternatively, the UE 104-a may perform measurements or data collection according to an existing configuration, while the logging and reporting configurations can be different (logging or reporting periodicity, filtering, etc.) for UE-sided LCM than the ones configured by the NE 102-a.

In some examples, the UE 104-a sends a new data collection indication (e.g., a data collection BSR to the gNB or NE 102-a). The information about the AI/ML LCM-related data to be transferred can be sent over a physical uplink control channel (PUCCH) (e.g., in uplink control information (UCI) or other control signaling). In some cases, the SR can be used as a common one bit indication for any AI/ML-related logged data or measurements. Additionally, or alternatively, the status report (e.g., the BSR) can be extended to include an additional bit to indicate the presence of AI/ML-related data for UE-sided LCM in the buffer. In some other examples, an SR is used to indicate the availability of AI/ML-related logged data. The SR may be an example of an existing SR and/or a new SR. The SR is used to indicate the availability of AI/ML-related logged data for UE-sided LCM. The SR may be reserved for the purpose of indicating the availability of logged AI/ML-related data for a UE-sided AI/ML LCM. In some other examples, the SR may indicate an amount of data in a buffer of the UE 104-a. Additionally, or alternatively, the SR may indicate a priority level (e.g., if present or received in a pre-configuration by the NE 102-a) of the data to be transmitted by the UE 104-a. If an ID of the parameter-set, functionality, or configuration is present at the UE 104-a while collecting or measuring the data, then the SR may also indicate the ID of the functionality, or the parameter-set provided by the network.

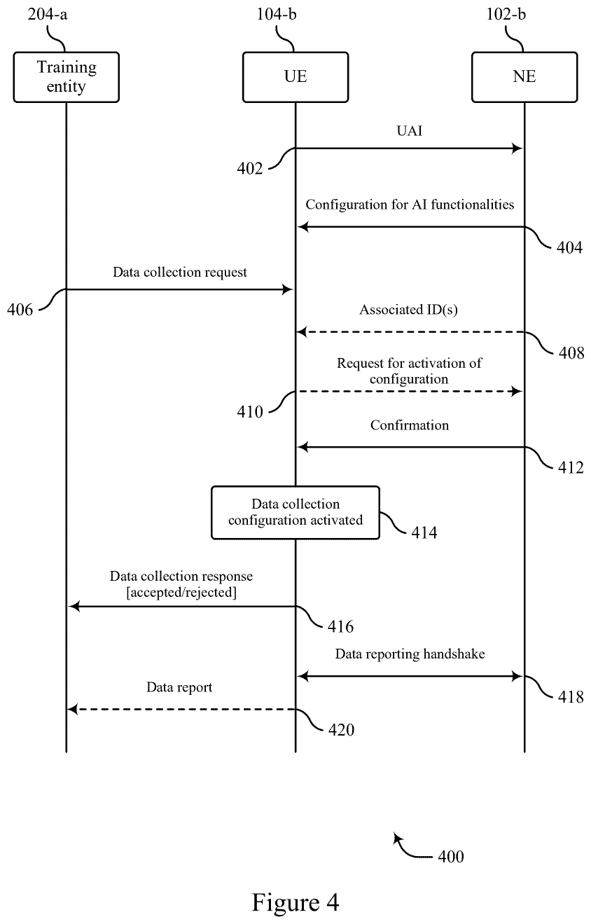

In some cases, the UE 104-a may receive a request for data collection from an external entity (e.g., the training entity 204), such as an OTT server or UE-side server. The data for training or monitoring of particular AI/ML use cases or sub-use cases may be a result of a measurement configuration from the NE 102-a. In some examples, the UE 104-a can be configured (e.g., preconfigured) by the NE 102-a with a respective parameter-set for each use-case or sub-use-case (e.g., AI functionality) proactively. The configuration may include the information (e.g., necessary information) that the UE 104-a uses to perform the measurements. The UE 104-a may activate the measurements if the UE 104-a does not receive any further reconfiguration from the NE 102-a. Additionally, or alternatively, the UE 104-a may perform the activation of the preconfigured measurement configuration, followed by a handshake between the UE 104-a and the gNB or LMF (e.g., the NE 102-a), which is described in further detail with respect to FIG. 4.

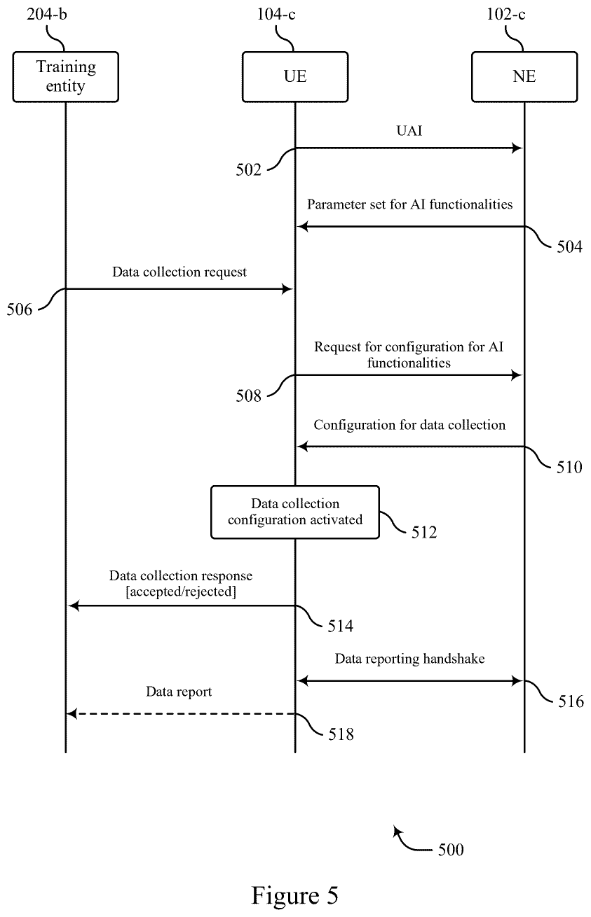

In some other examples, the UE 104-a and gNB or LMF (e.g., the NE 102-a) may exchange information about the UE-sided functionalities, which is described in further detail with respect to FIG. 5. For example, the UE 104-a may transmit an RRC message (e.g., UE assistance information (UAI) message) to indicate its one or more supported UE-sided AI functionalities, and/or a respective parameter-set that the UE 104-a can be configured to measure. Upon receiving a request or via internal triggering conditions, the UE 104-a may request the NE 102-a to provide a measurement configuration for a defined AI functionality (e.g., use-case or sub-use-case) or for a defined parameter-set (e.g., including one or more parameters) preconfigured by the NE 102-a. The request from the UE 104-a may include an indication of one or more IDs of AI functionalities (e.g., functionality_ID) and/or one or more IDs of the parameter-set (e.g., parameter_ID). The request can be sent to the NE 102-a or gNB as an RRC message. Additionally, or alternatively, the request may be sent on a PUCCH (e.g., in uplink control information (UCI)). Thus, the NE 102-a can configure the UE 104-a with a new measurement configuration for the parameter-set in response to the request from the UE 104-a. The parameter-set included in the new or updated measurement configuration can include a subset of the parameter-set requested by the UE 104-a.

In some other examples, the UE 104-a may send a direct request to the gNB, NE 102-a, or LMF to provide a measurement configuration for one or more AI functionalities for UE-sided AI/ML LCM without prior interaction or information exchange with respect to UE-sided AI/ML LCM, which is described in further detail with respect to FIG. 5. The request may include an indication of the respective AI functionalities for which the UE 104-a requests to perform data collection. Additionally, or alternatively, the UE 104-a may indicate a list of functionality-specific parameters, which may be configured by the NE 102-a. The UE 104-a request may be triggered upon receiving a data collection request from one of the UE-sided training entities (e.g., the training entity 204), such as a UE-server, an OTT server, a CN, or an OAM.

The gNB, NE 102-a, or LMF can configure the UE 104-a to send a proactive measurement configuration request for AI/ML LCM. Upon receiving a measurement configuration request, the gNB, NE 102-a, or LMF may determine whether to provide a measurement configuration to the UE 104-a based on existing measurement configurations (e.g., to supplement existing measurement configurations or avoid reconfiguring measurements configured in the existing measurement configurations). In some examples, the UE 104-a may send the parameters that the UE 104-a is to collect to a gNB and then the gNB selects a configuration to enable the UE 104-a to collect the parameters. In some other examples, the UE 104-a may send the parameters that the UE 104-a is to collect to the LMF or a network node and then the LMF or the network node selects a configuration for the UE 104-a to use and requests the gNB to enable the UE 104-a to collect the parameters according to the selected configuration. In some other examples, the gNB (e.g., the NE 102-a) has previously communicated with the UE 104-a, LMF, a data collection entity, and/or the training entity 204 (e.g., via the communications link 202-c) the set of configurations that the gNB can provide, and the UE 104-a, LMF, the data collection entity, or training entity 204 selects a configuration. In some other examples, the structure of the data collection request is defined (e.g., what fields can be included and what is the range of each field), and then the data collection request is constructed based on that format and the data criterion (e.g., requirement).

At 206, the UE 104-a uses the configuration to collect the data. In some cases, the UE 104-a may perform a handshake with the NE 102-a to request permission to share the collected data or start the sharing or transmission of collected data with the training entity 204. Upon successful completion of the handshake procedure, the UE 104-a may transmit the collected data to the training entity 204. For example, the UE 104-a may transmit the collected data to the training entity 204 according to a reporting configuration (e.g., periodically and/or using one or more configured time-frequency resources) provisioned by the training entity 204 or the NE 102-a to the UE 104-a. The UE 104-a may additionally, or alternatively, transmit the collected data to the NE 102-a for the NE 102-a to use for some measurement procedures and/or for AI functionalities. At 208, the training entity 204 may train one or more AI functionalities (e.g., AI/ML models) using the collected data. The training entity may transmit the trained models to the UE 104-a for the UE to apply, implement, update, fine-tune, and/or monitor the AI functionalities. For example, the UE 104-a may provide one or more values as input to the learning models and may receive an output.

For a beam management AI functionality, the inputs may include signal strength measurements, angle of arrival data, and historical connection quality metrics, and the outputs may include a beam selection or prediction of future beam switches. For a CSI prediction AI functionality, the UE 104-a may provide current channel measurements, user mobility data, and environmental factors as input to the models, and may receive forecasts of future channel conditions as output from the models. For a measurement prediction AI functionality, the inputs may include historical measurement data, current network load information, and user location, and the outputs may include estimated future signal strengths or quality indicators. For an RLF prediction AI functionality, the inputs may include current signal quality, historical connection stability data, and network congestion levels, and the output may include probability scores for potential link failures or recommendations for preemptive actions.

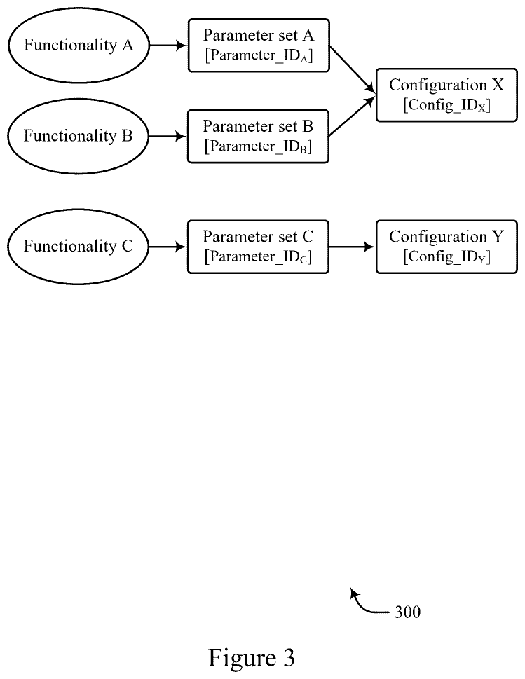

FIG. 3 illustrates an example AI functionality diagram 300 in accordance with aspects of the present disclosure. In some examples, the AI functionality diagram 300 implements or is implemented by aspects of the wireless communications system 100 and the wireless communications system 200. For example, the AI functionality diagram 300 may be implemented by a UE and/or a NE, which may be examples of the corresponding devices as described with reference to FIGS. 1 and 2. A NE may configure data collection for AI functionalities at the UE.

In some cases, one or more parameters used for training a UE-sided model (e.g., for AI functionalities at a UE) may include measurement quantities as well as additional metrics, which can be obtained from the UE directly without intervention from a gNB or a NE. Therefore, a parameter-set which can be configured by the gNB, NE, or LMF may include the parameters that the UE uses assistance or a relevant configuration from the gNB, NE, or LMF to measure (e.g., obtain, collect). The functionalities may be mapped to different parameter sets, which may then be mapped to configurations. Thus, the UE may manage access to the AI functionalities, such that a NE may not be aware of the AI functionalities at the UE. Instead, the NE may determine a configuration using a parameter set ID. For example, a Functionality A may be mapped to a parameter set A with a corresponding ID (e.g., Parameter_ID_{A}), a Functionality B may be mapped to a parameter set B with a corresponding ID (e.g., Parameter_ID_{B}), and a Functionality C may be mapped to a parameter set C with a corresponding ID (e.g., Parameter_ID_{C}). The parameter IDs may be mapped to a configuration.

In some cases, multiple parameter IDs may be mapped to a single configuration. For example, a Parameter_ID_{A} and a Parameter_ID_{B} may be mapped to Configuration X with a corresponding configuration ID (e.g., Config_ID_{X}). In some other cases, individual parameter IDs may be mapped to different configurations. For example, a Parameter_ID_{C} may be mapped to Configuration Y with a corresponding configuration ID (e.g., Config_ID_{Y}).

In some examples, a gNB may share one or more additional conditions with the UE or UE-side or the training entity to support AI/ML training or monitoring. The gNB may share the additional conditions in the form of associated IDs, such as upon request from the UE or proactively when the additional conditions at the NW-side are changed. If the associated IDs are shared proactively, then the UE may or may not require additional information (e.g., new configuration) from the gNB if the relevant configuration for AI/ML LCM is available at the UE. In some cases, the UE may determine whether to initiate the data collection, such that the UE may not be required to seek additional approval from the gNB. In some other cases, the UE may be configured to provide an indication of a start or a stop of the UE-sided data collection, such as an indication of data collection (e.g., measurement) being initiated and logged. For example, the UE may transmit signaling to one or more NEs (e.g., a NE and/or a training entity) that indicates information, such as one or more of an initiation and termination of collecting the data or additional details, including assistance information, related to collection of the data (for one or more use-cases, functionalities, parameters, etc.). The data collection for UE-sided AI/ML training or monitoring and a periodicity may depend on the data collection request that the UE receives from the training entity, OTT server, CN, or OAM. Additionally, or alternatively, the UE may send information to the gNB or NE or LMF about the data collection configuration, such as a periodicity of measurements and logging. In some examples, the gNB may configure the UE with measurements, logging, and/or reporting configuration for the UE-sided LCM. The measurements, logging, and/or reporting configuration can be enabled upon request from the UE to the NE or gNB.

FIG. 4 illustrates an example signaling diagram 400 in accordance with aspects of the present disclosure. In some examples, the signaling diagram 400 implements or is implemented by aspects of the wireless communications system 100, the wireless communications system 200, and the AI functionality diagram 300. The signaling diagram 400 may implement or be implemented by a UE 104-b, a NE 102-b, and a training entity 204-a, which may be examples of the corresponding devices as described with reference to FIGS. 1 through 3. For example, the NE 102-b may provide the UE 104-b with a configuration for collecting data (e.g., data for AI functionalities) to provide to the training entity 204-a. Alternative examples of the following may be implemented, where some processes are performed in a different order than described or are not performed. In some cases, processes may include additional features not mentioned below, or further processes may be added.

In some examples, the training entity 204-a may be an example of a NE or may be implemented by a NE (e.g., a CN and/or an OAM). In some other examples, the training entity 204-a may be an example of a server or other device implemented by the UE 104-b (e.g., an OTT server, or other server implemented by the UE 104-b). The NE 102-b may be an example of a base station (e.g., gNB) or an LMF.

At 402, the UE 104-b transmits a UAI message to the NE 102-b. For example, the UE 104-b transmits information about one or more AI functionalities to the NE 102-b using a UE capability message. The UAI message may indicate one or more AI functionalities supported by the UE 104-b. The AI functionalities may include, but are not limited to, a beam management procedure, a CSI prediction procedure, a measurement prediction, or an RLF prediction. At 404, the NE 102-b responds by transmitting a configuration for AI functionalities message to the UE 104-b. The configuration may include parameter sets corresponding to the AI functionalities indicated in the UAI message.

At 406, the training entity 204-a transmits a data collection request to the UE 104-b. The data collection request may specify one or more AI functionalities or parameters for which the training entity 204-a requests data. At 408, the NE 102-b may optionally transmit one or more associated IDs to the UE 104-b. The associated IDs may correspond to network conditions at the NE 102-b or other relevant information for AI/ML training.

At 410, the UE 104-b transmits a request for activation of a configuration to the NE 102-b (e.g., in RRC signaling). This request may be triggered by the data collection request received from the training entity 204-a. The UE 104-b may request activation of a configuration corresponding to the AI functionalities or parameters specified or parameters indicated in the data collection request. In some examples, the NE 102-b may approve (e.g., accept) or reject the data collection request (e.g., configuration or activation request) from the UE 104-c. In some examples, the request is for at least one of a measurement configuration for measuring the data, a logging configuration for logging the data, or a reporting configuration for reporting the data. The configuration may include the at least one of the measurement configuration, the logging configuration, or the reporting configuration. In some cases, the configuration includes one or more of measurement quantities for the data, time-frequency resources for the collection of the data, or metrics (e.g., criterion) of the one or more AI functionalities at the UE 104-b.

At 412, the NE 102-b responds with a confirmation message to the UE 104-b. The confirmation may indicate that the requested configuration has been activated. At 414, the UE 104-b activates the data collection configuration.

At 416, the UE 104-b transmits a data collection response to the training entity 204-a. This response may indicate whether the data collection request has been accepted or rejected based on the activated configuration and the capabilities of the UE to implement the configuration or the AI functionalities.

The UE 104-a may perform the activation of the preconfigured measurement configuration, followed by a handshake between the UE 104-a and the NE 102-b. If the handshake is successful, then the UE 104-b may begin collecting data according to the activated configuration. If the handshake is not successful, then the UE 104-b may refrain from (e.g., cancel) the data collection, and may request an additional configuration from the NE 102-b for collecting the data. Additionally, or alternatively, the NE 102-b may configure the UE 104-b to conditionally activate a preconfigured measurement configuration upon meeting a trigger condition configured by the NE 102-b. The UE 104-b may send an indication to the NE 102-b informing the NE 102-b about the activation or deactivation (e.g., start or stop) of a measurement configuration.

For example, at 418, a data reporting handshake occurs between the UE 104-b and the NE 102-b. This handshake may involve coordination and preparation for data collection and data transfer. If the data reporting handshake is successful, then the UE 104-b may initiate transmission of a data (e.g., collected according to the provided configuration) report to the training entity 204-a. If the data reporting handshake is unsuccessful, then the UE 104-b may cancel (e.g., terminate, not transmit) transmission of the data report to the training entity 204-a.

In some cases, the UE 104-b may transmit at least one of a status report (e.g., a BSR) or an SR that indicates at least one of a presence of the data in a buffer of the UE 104-b, an availability of the data, an amount of the data in the buffer, a priority level of the data, or an ID of the one or more AI functionalities at the UE 104-b. For example, at 420, the UE 104-b optionally transmits the data report to the training entity 204-a. The data report may include data collected by the UE 104-b for the AI functionalities. The training entity 204-a may use the data in the data report to train one or more models (e.g., AI/ML models) for the AI functionalities. The training entity 204-a may transmit the trained models to the UE 104-b for implementation. In some examples, the UE 104-b receives signaling that requests the data and that indicates a periodicity for collecting the data. The UE 104-b may indicate the periodicity for collecting the data to the NE 102-b (e.g., in a request for a configuration for collecting the data).

FIG. 5 illustrates an example signaling diagram 500 in accordance with aspects of the present disclosure. In some examples, the signaling diagram 500 implements or is implemented by aspects of the wireless communications system 100, the wireless communications system 200, the AI functionality diagram 300, and the signaling diagram 400. The signaling diagram 500 may implement or be implemented by a UE 104-c, a NE 102-c, and a training entity 204-b, which may be examples of the corresponding devices as described with reference to FIGS. 1 through 4. For example, the NE 102-c may provide the UE 104-c with a configuration for collecting data (e.g., data for AI functionalities) to provide to the training entity 204-b. Alternative examples of the following may be implemented, where some processes are performed in a different order than described or are not performed. In some cases, processes may include additional features not mentioned below, or further processes may be added.

In some examples, the training entity 204-b may be an example of a NE or may be implemented by a NE (e.g., a CN and/or an OAM). In some other examples, the training entity 204-b may be an example of a server or other device implemented by the UE 104-c (e.g., an OTT server, or other server implemented by the UE 104-c). The NE 102-c may be an example of a base station (e.g., gNB) or an LMF.

At 502, the UE 104-c transmits a UAI message to the NE 102-c. The UAI message may indicate one or more AI functionalities supported by the UE 104-c. At 504, the NE 102-c responds to the UE 104-c by transmitting signaling that includes a parameter set for AI functionalities. The parameter set may correspond to the AI functionalities indicated in the UAI message (e.g., AI functionalities for which the training entity 204-b is to perform AI/ML training). For example, the signaling may include respective information related to one or more parameters mapped to the one or more AI functionalities at the UE 104-c. The respective information related to the one or more parameters includes at least one of a list of parameters or a time-frequency configuration for the one or more parameters.

At 506, the training entity 204-b transmits a data collection request to the UE 104-c. The data collection request may specify one or more AI functionalities or parameters for which the training entity 204-b requests data.

At 508, the UE 104-c transmits a request for a configuration for AI functionalities to the NE 102-c (e.g., in RRC signaling). This request may be triggered by the data collection request received from the training entity 204-b. The UE 104-c may request a configuration corresponding to the AI functionalities or parameters specified in the data collection request. In some examples, the training entity 204-b may transmit the data collection request directly to the NE 102-c, such that the UE 104-c may optionally transmit the request for configuration for the AI functionalities to the NE 102-c. In some examples, the NE 102-c may approve (e.g., accept) or reject the data collection request (e.g., configuration request) from the UE 104-c.

In some cases, the UE 104-c receives signaling prior to transmitting the request for the configuration. The signaling indicates a set of configurations (e.g., including the configuration) for collection of respective data for AI functionalities. That is, the NE 102-c may preconfigure a set of configurations at the UE 104-c. The request may request activation of the configuration from the set of configurations.

At 510, the NE 102-c responds with a configuration for data collection message to the UE 104-c. Additionally, or alternatively, the NE 102-c may respond with instructions to activate the configuration from a set of configurations defined (e.g., preconfigured) at the UE 104-c. The configuration may include measurement quantities, time-frequency resources, or other parameters for the requested data collection. At 512, the UE 104-c activates the data collection configuration. This provides for the UE 104-c to begin collecting data according to the provided configuration (e.g., upon successful completion of a handshake procedure with the NE 102-c).

At 514, the UE 104-c transmits a data collection response to the training entity 204-b. This response may indicate whether the data collection request has been accepted or rejected based on the activated configuration and one or more capabilities of the UE 104-c to implement the configuration or the AI functionalities.

In some examples, at 516, a data reporting handshake occurs between the UE 104-c and the NE 102-c. This handshake may involve coordination and preparation for data collection and data transfer. If the data reporting handshake is successful, then the UE 104-c may initiate transmission of a data (e.g., collected according to the provided configuration) report to the training entity 204-b. If the data reporting handshake is unsuccessful, then the UE 104-c may cancel (e.g., terminate, not transmit) transmission of the data report to the training entity 204-b.

In some cases, at 518, the UE 104-c optionally transmits the data report to the training entity 204-b. The data report may include data collected by the UE 104-c for the AI functionalities. The training entity 204-b may use the data in the data report to train one or more models (e.g., AI/ML models) for the AI functionalities. The training entity 204-b may transmit the trained models to the UE 104-c for implementation.

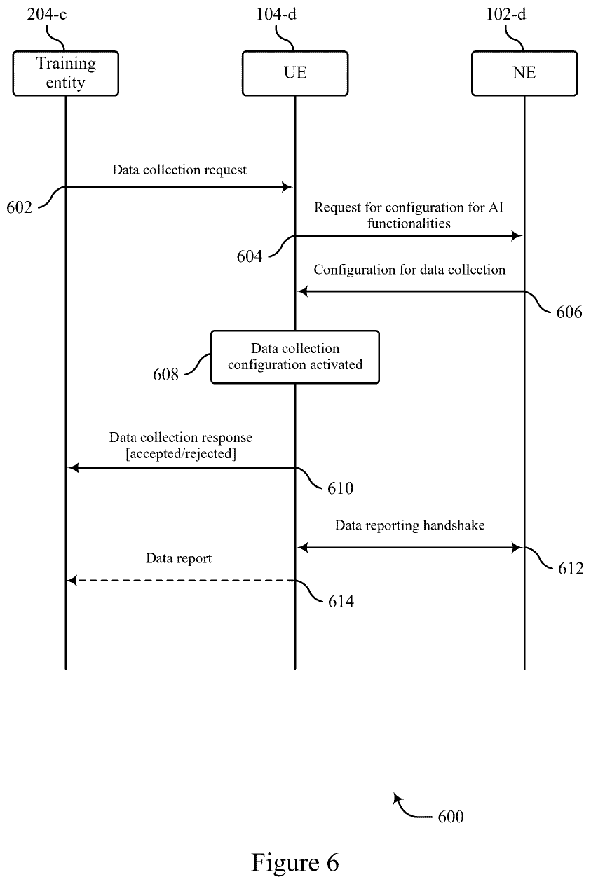

FIG. 6 illustrates an example signaling diagram 600 in accordance with aspects of the present disclosure. In some examples, the signaling diagram 600 implements or is implemented by aspects of the wireless communications system 100, the wireless communications system 200, the AI functionality diagram 300, the signaling diagram 400, and the signaling diagram 500. The signaling diagram 600 may implement or be implemented by a UE 104-d, a NE 102-d, and a training entity 204-c, which may be examples of the corresponding devices as described with reference to FIGS. 1 through 5. For example, the NE 102-d may provide the UE 104-d with a configuration for collecting data (e.g., data for AI functionalities) to provide to the training entity 204-c. Alternative examples of the following may be implemented, where some processes are performed in a different order than described or are not performed. In some cases, processes may include additional features not mentioned below, or further processes may be added.

In some examples, the training entity 204-c may be an example of a NE or may be implemented by a NE (e.g., a CN and/or an OAM). In some other examples, the training entity 204-c may be an example of a server or other device implemented by the UE 104-d (e.g., an OTT server, or other server implemented by the UE 104-d). The NE 102-d may be an example of a base station (e.g., gNB) or an LMF.

At 602, the training entity 204-c transmits a data collection request to the UE 104-d. The data collection request may specify one or more AI functionalities or parameters for which the training entity 204-c requests data. The data collection request can be generated by the NE 102-d, the training entity 204-c (e.g., which may be an example of another NE), an external server, a UE-sided server, or the UE 104-d. The training entity 204-c transmits the data collection request to obtain data for training one or more AI functionalities (e.g., AI/ML models). There may be one or more models per functionality (e.g., use case or sub-use case).

At 604, the UE 104-d transmits a request for configuration for AI functionalities to the NE 102-d (e.g., in RRC signaling). This request may be triggered by the data collection request received from the training entity 204-c. The UE 104-d may request a configuration corresponding to the AI functionalities or parameters specified in the data collection request.

At 606, the NE 102-d responds to the UE 104-d with a configuration for data collection. The configuration may include measurement quantities, time-frequency resources, or other parameters needed for the requested data collection. Additionally, or alternatively, the configuration may include respective sets of parameters corresponding to the one or more AI functionalities (e.g., AI functionalities at the UE 104-d).

At 608, the UE 104-d activates the data collection configuration. At 610, the UE 104-d transmits a data collection response to the training entity 204-c. This response may indicate whether the data collection request has been accepted or rejected based on the activated configuration and the UE's capabilities.

In some examples, at 612, a data reporting handshake occurs between the UE 104-d and the NE 102-d. This handshake may involve coordination and preparation for data collection and data transfer. If the data reporting handshake is successful, then the UE 104-d may initiate transmission of a data (e.g., collected according to the provided configuration) report to the training entity 204-c. If the data reporting handshake is unsuccessful, then the UE 104-d may cancel (e.g., terminate, not transmit) transmission of the data report to the training entity 204-c.

In some cases, at 614, the UE 104-d optionally transmits the data report to the training entity 204-c. The data report may include data collected by the UE 104-d for the AI functionalities. The training entity 204-c may use the data in the data report to train one or more models (e.g., AI/ML models) for the AI functionalities. The training entity 204-c may transmit the trained models to the UE 104-d for implementation.

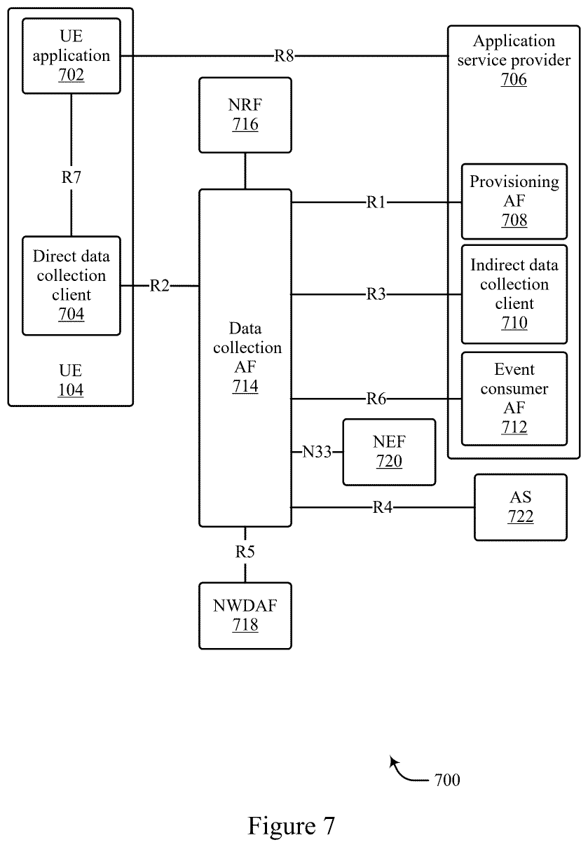

FIG. 7 illustrates an example network diagram 700 in accordance with aspects of the present disclosure. In some examples, the network diagram 700 implements or is implemented by aspects of the wireless communications system 100, the wireless communications system 200, the AI functionality diagram 300, the signaling diagram 400, the signaling diagram 500, and the signaling diagram 600. For example, the network diagram 700 may be implemented by a UE and/or a NE, which may be examples of the corresponding devices as described with reference to FIGS. 1 through 6. A NE may configure data collection for AI functionalities at the UE.

In some cases, a 104 which include or may implement a UE application 702 and a direct data collection client 704. The UE application 702 is connected to the direct data collection client 704 via interface R7. The UE application 702 may represent various AI functionalities implemented at the UE 104, such as a beam management algorithm, CSI prediction model, or an RLF prediction system. For example, a beam management application might analyze signal strength data to optimize antenna configurations, while a CSI prediction model could forecast channel conditions to enhance link adaptation. The direct data collection client 704 may act as an intermediary between the AI applications and the network. For a beam management application, the direct data collection client 704 may collect signal strength measurements, AoA information, and historical connection quality metrics. For a CSI prediction model, the direct data collection client 704 may obtain current channel measurements, user mobility data, and environmental factors. The direct data collection client 704 may manage the implementation of measurement configurations received from the network, adjusting data collection parameters based on network instructions to improve the relevance and efficiency of the gathered data for AI model training and refinement.

An application service provider 706 may be connected to the UE application 702 through interface R8. The application service provider 706 may include a provisioning access function (AF) 708, an indirect data collection client 710, and an event consumer AF 712. An application service provider 706 may offer various AI services to enhance user experience and network performance. For example, the application service provider 706 may provide a cloud-based beam management service that leverages data from multiple UEs to optimize antenna configurations across a network. The provisioning AF 708 implemented by the application service provider may be responsible for configuring UEs with appropriate parameter sets for data collection related to AI functionalities. The AF 708 may dynamically adjust the configurations based on network conditions or evolving AI model criterion. The indirect data collection client 710 may gather aggregated or anonymized data from multiple UEs, enabling training of AI models on a broader dataset while maintaining user privacy. The indirect data collection client 710 may implement data filtering and preprocessing techniques to ensure the quality and relevance of collected data. The event consumer AF 712 may monitor network events and AI model performance metrics, triggering data collection or model updates when certain conditions are met. For example, the event consumer AF 712 may initiate additional data gathering for CSI prediction models when network congestion reaches a threshold value.

A data collection AF 714 may serve as a central hub for the UE 104 and the application service provider 706. The data collection AF 714 interfaces with the direct data collection client 704 via an R2 interface, the indirect data collection client 710 via an R3 interface, the provisioning AF 708 via an R1 interface, and the event consumer AF 712 via an R6 interface. The direct data collection client 704 may handle the formatting and transmission of the collected data to a data collection AF 714.

The data collection AF 714 may be connected to a network repository function (NRF) 716 and a network data analytics function (NWDAF) 718 (e.g., via an R5 interface). An NRF 716 may be a network function that maintains information about network function instances and corresponding supported services. The NRF 716 may enable other network functions to discover and communicate with each other. The NWDAF 718 may be a network function that collects and analyzes data from various network functions and provides analytics and predictions to support network automation and optimization. The NWDAF 718 may use machine learning techniques to process network data and generate insights for improving network performance and user experience.

The data collection AF 714 may also be connected to a network exposure function (NEF) 720 and an application server (AS) 724. For example, the data collection AF 714 is connected to an NEF 720 via an N33 interface and to the AS 722 via an R4 interface. The NEF 720 may be an example of a network function that securely exposes network capabilities and services to external applications. The NEF 720 may act as an intermediary between a CN and external entities, managing access to network services and data. The AS 722 may be a server that hosts and runs applications or services. For example, the AS 722 may provide various functionalities or services to the UE 104, including AI-related services or data processing capabilities.

In some examples, an NE configures the UE 104 with a parameter-set for each AI functionality (e.g., sub-use case or a group of use-cases). A data collection AF 714 sends a data collection configuration including the respective AI functionalities. A data collection client (e.g., the indirect data collection client 710) maps the data collection configuration to a data collection request for that functionality and sends the data collection request to the UE 104. Based on the functionality indication received by the UE 104 and the preconfigured parameter-set (e.g., by the NE) for that functionality, the UE 104 determines the list of parameters to be measured. The UE 104 can send a request to the NE to configure the UE for data collection for the parameter-set or to activate the configuration (e.g., which is already provided). The request may include, but is not limited to, an indication of the AI functionality and the preconfigured parameter-set ID. In response, the NE configures the UE 104 with the measurement configuration for the requested functionality or activates an existing configuration with a configuration ID. The NE may associate a priority to the measurement configuration. The UE may use the configuration ID or the priority for reporting the data and as part of a data reporting SR or a data collection BSR. The data collection request can represent the parameters or configuration that supports the gNB or NE to provide an appropriate measurement configuration for a functionality. The mapping of data collection configuration to data collection request can be either performed by the data collection AF 714 directly, which sends the request (e.g., including the details of the required parameters or configurations) to the UE 104, or the UE 104 can perform the mapping to the data collection request (e.g., details of the parameters/configurations) upon receiving a request from the 714//.

In some other examples, a NE may configure a UE 104 with a parameter-set, or the parameter-set may be specified for AI/ML LCM. A data collection AF 714 sends a data collection configuration (e.g., including a list of data or parameters to be collected) to the data collection client. The structure of the configuration can be specified and may include an ID. A data collection client (e.g., the indirect data collection client 710) can map the data collection configuration to a data collection request and send the data collection request to the UE 104. Based on the received request by the UE 104 and the preconfigured parameter-set (e.g., by the NE) or specified information for that AI/ML, the UE 104 can determine the request for a measurement configuration or data collection. The UE 104 can send a request to the NE, to configure the UE 104 for data collection for the parameter-set or to activate the configuration (e.g., which is already provided). The request may include, but is not limited to, an indication of the required data or parameters and the preconfigured parameter-set ID. In response, the NE can configure the UE 104 with the measurement configuration for the requested data or activates an existing configuration with a configuration ID. The NE may associate a priority to the measurement configuration. The configuration ID or the priority is used for reporting the data and as part of a data reporting SR or a data collection BSR.

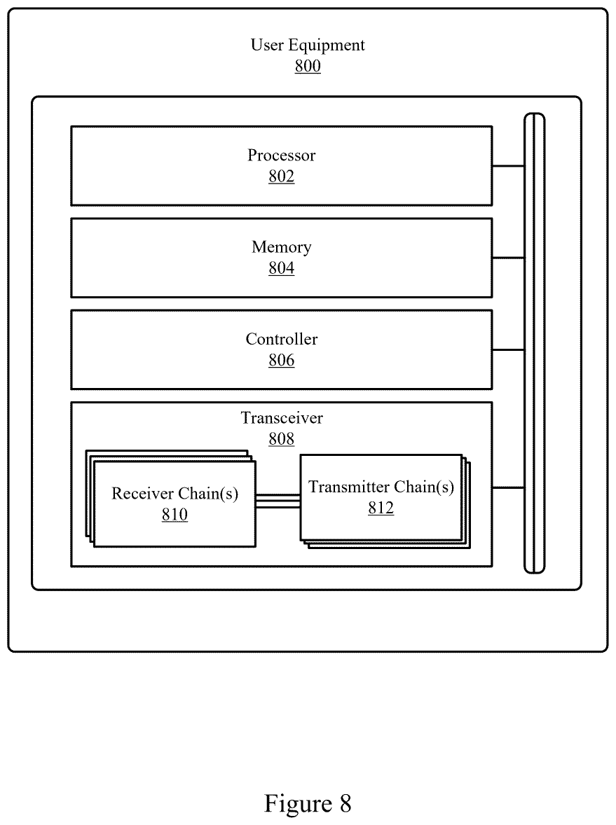

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for transmitting first signaling that requests a configuration for collection of data for one or more AI functionalities, receiving, responsive to the first signaling, second signaling that indicates the configuration for the collection of the data, and collecting the data based on the configuration.

Additionally, the UE 800 may be configured to support any one or combination of the configuration includes respective sets of parameters corresponding to the one or more AI functionalities, where the one or more AI functionalities are at the UE 800. Additionally, or alternatively, the UE 800 may be configured to support performing a handshake procedure with an NE prior to collecting the data. Additionally, or alternatively, the UE 800 may be configured to support transmitting third signaling that indicates information corresponding to a set of AI functionalities supported by the UE 800, where the set of AI functionalities includes the one or more AI functionalities and receiving fourth signaling that indicates respective information related to one or more parameters corresponding to the one or more AI functionalities at the UE 800, where the respective information related to the one or more parameters includes at least one of a list of parameters or a time-frequency configuration for the one or more parameters. Additionally, or alternatively, the first signaling indicates one or more of the one or more AI functionalities performed or performable by the UE the UE 800, an ID of the one or more AI functionalities performed or performable by the UE the UE 800, a respective set of parameters corresponding to the one or more AI functionalities performed or performable by the UE the UE 800, or an ID of the respective set of parameters corresponding to the one or more AI functionalities performed or performable by the UE the UE 800.

Additionally, or alternatively, the UE 800 may be configured to support receiving, prior to the first signaling, third signaling that indicates a set of configurations for collection of respective data for a set of AI functionalities, where the set of configurations includes the configuration, the first signaling requests activation of the configuration, and the second signaling activates the configuration. Additionally, or alternatively, the one or more AI functionalities at the UE 800 include one or more of a beam management procedure, a CSI prediction procedure, a measurement prediction, or an RLF prediction. Additionally, or alternatively, the UE 800 may be configured to support receiving third signaling that indicates associated IDs corresponding to one or more conditions at an NE. Additionally, or alternatively, the UE 800 may be configured to support transmitting third signaling that accepts the collection of the data or rejects the collection of the data.

Additionally, or alternatively, the UE 800 may be configured to support transmitting third signaling that indicates information for initiating or terminating data collection, or indicates assistance information for the data collection. Additionally, or alternatively, the UE 800 may be configured to support receiving third signaling that requests the data, where the third signaling indicates a periodicity for collecting the data, and where the first signaling includes the periodicity for collecting the data. Additionally, or alternatively, the UE 800 may be configured to support to transmit at least one of a status report or a SR that indicates at least one of a presence of the data in a buffer associated with the UE 800, an availability of the data, an amount of the data in the buffer, a priority level associated with the data, or an ID associated with the one or more AI functionalities at the UE 800.

Additionally, or alternatively, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. Additionally, or alternatively, the configuration includes one or more of measurement quantities associated with the data, time-frequency resources associated with the collection of the data, or metrics associated with the one or more AI functionalities at the UE 800. Additionally, or alternatively, the first signaling includes RRC signaling.

Additionally, or alternatively, the UE 800 may support at least one memory (e.g., the memory 804) and at least one processor (e.g., the processor 802) coupled with the at least one memory and configured to cause the UE to transmit first signaling that requests a configuration for collection of data for one or more AI functionalities, receive, responsive to the first signaling, second signaling that indicates the configuration for the collection of the data, and collect the data based on the configuration.

Additionally, the UE 800 may be configured to support any one or combination of the configuration includes respective sets of parameters corresponding to the one or more AI functionalities, where the one or more AI functionalities are at the UE 800. Additionally, or alternatively, the UE 800 may be configured to support to perform a handshake procedure with an NE prior to collecting the data. Additionally, or alternatively, the UE 800 may be configured to support to transmit third signaling that indicates information corresponding to a set of AI functionalities supported by the UE 800, where the set of AI functionalities includes the one or more AI functionalities and receive fourth signaling that indicates respective information related to one or more parameters corresponding to the one or more AI functionalities at the UE, where the respective information related to the one or more parameters includes at least one of a list of parameters or a time-frequency configuration for the one or more parameters. Additionally, or alternatively, the first signaling indicates one or more of the one or more AI functionalities performed or performable by the UE the UE 800, an ID of the one or more AI functionalities performed or performable by the UE the UE 800, a respective set of parameters corresponding to the one or more AI functionalities performed or performable by the UE the UE 800, or an ID of the respective set of parameters corresponding to the one or more AI functionalities performed or performable by the UE the UE 800.

Additionally, or alternatively, the UE 800 may be configured to support to receive, prior to the first signaling, third signaling that indicates a set of configurations for collection of respective data for a set of AI functionalities, where the set of configurations includes the configuration, the first signaling requests activation of the configuration, and the second signaling activates the configuration. Additionally, or alternatively, the one or more AI functionalities at the UE 800 include one or more of a beam management procedure, a CSI prediction procedure, a measurement prediction, or an RLF prediction. Additionally, or alternatively, the UE 800 may be configured to support to receive third signaling that indicates associated IDs corresponding to one or more conditions at an NE. Additionally, or alternatively, the UE 800 may be configured to support to transmit third signaling that accepts the collection of the data or rejects the collection of the data.

Additionally, or alternatively, the UE 800 may be configured to support to transmit third signaling that indicates information for initiating or terminating data collection, or indicates assistance information for the data collection. Additionally, or alternatively, the UE 800 may be configured to support to receive third signaling that requests the data, where the third signaling indicates a periodicity for collecting the data, and where the first signaling includes the periodicity for collecting the data. Additionally, or alternatively, the UE 800 may be configured to support to transmit at least one of a status report or a SR that indicates at least one of a presence of the data in a buffer associated with the UE 800, an availability of the data, an amount of the data in the buffer, a priority level associated with the data, or an ID associated with the one or more AI functionalities at the UE 800.

Additionally, or alternatively, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. Additionally, or alternatively, the configuration includes one or more of measurement quantities associated with the data, time-frequency resources associated with the collection of the data, or metrics associated with the one or more AI functionalities at the UE 800. Additionally, or alternatively, the first signaling includes RRC signaling.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

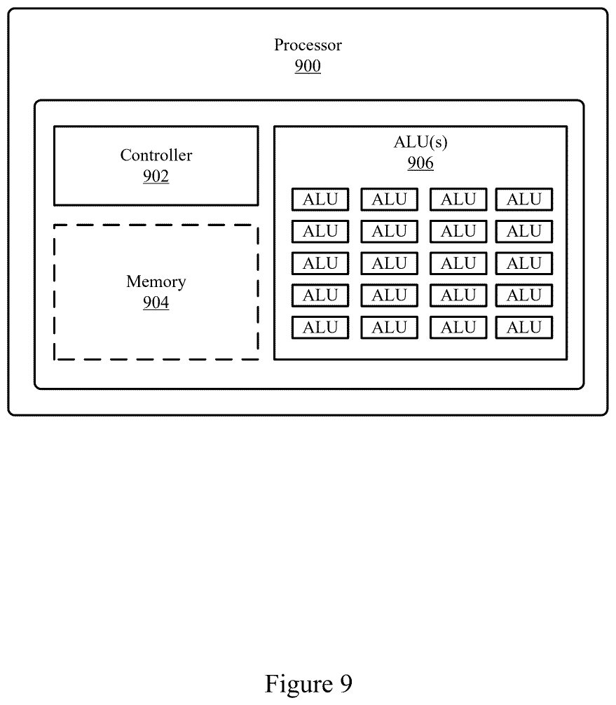

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to transmit first signaling that requests a configuration for collection of data for one or more AI functionalities, receive, responsive to the first signaling, second signaling that indicates the configuration for the collection of the data, and collect the data based on the configuration.

Additionally, the processor 900 may be configured to support any one or combination of the configuration includes respective sets of parameters corresponding to the one or more AI functionalities, where the one or more AI functionalities are at the processor 900. Additionally, or alternatively, the processor 900 may be configured to support to perform a handshake procedure with an NE prior to collecting the data. Additionally, or alternatively, the processor 900 may be configured to support to transmit third signaling that indicates information corresponding to a set of AI functionalities supported by the processor 900, where the set of AI functionalities includes the one or more AI functionalities and receive fourth signaling that indicates respective information related to one or more parameters corresponding to the one or more AI functionalities at the processor 900, where the respective information related to the one or more parameters includes at least one of a list of parameters or a time-frequency configuration for the one or more parameters. Additionally, or alternatively, the first signaling indicates one or more of the one or more AI functionalities performed or performable by the processor 900, an ID of the one or more AI functionalities performed or performable by the processor 900, a respective set of parameters corresponding to the one or more AI functionalities performed or performable by the processor 900, or an ID of the respective set of parameters corresponding to the one or more AI functionalities performed or performable by the processor 900.

Additionally, or alternatively, the processor 900 may be configured to support to receive, prior to the first signaling, third signaling that indicates a set of configurations for collection of respective data for a set of AI functionalities, where the set of configurations includes the configuration, the first signaling requests activation of the configuration, and the second signaling activates the configuration. Additionally, or alternatively, the one or more AI functionalities at the processor 900 include one or more of a beam management procedure, a CSI prediction procedure, a measurement prediction, or an RLF prediction. Additionally, or alternatively, the processor 900 may be configured to support to receive third signaling that indicates associated IDs corresponding to one or more conditions at an NE. Additionally, or alternatively, the processor 900 may be configured to support to transmit third signaling that accepts the collection of the data or rejects the collection of the data.

Additionally, or alternatively, the processor 900 may be configured to support to transmit third signaling that indicates information for initiating or terminating data collection, or indicates assistance information for the data collection. Additionally, or alternatively, the processor 900 may be configured to support to receive third signaling that requests the data, where the third signaling indicates a periodicity for collecting the data, and where the first signaling includes the periodicity for collecting the data. Additionally, or alternatively, the processor 900 may be configured to support to transmit at least one of a status report or a SR that indicates at least one of a presence of the data in a buffer associated with the processor 900, an availability of the data, an amount of the data in the buffer, a priority level associated with the data, or an ID associated with the one or more AI functionalities at the processor 900.

Additionally, or alternatively, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. Additionally, or alternatively, the configuration includes one or more of measurement quantities associated with the data, time-frequency resources associated with the collection of the data, or metrics associated with the one or more AI functionalities at the processor 900. Additionally, or alternatively, the first signaling includes RRC signaling.

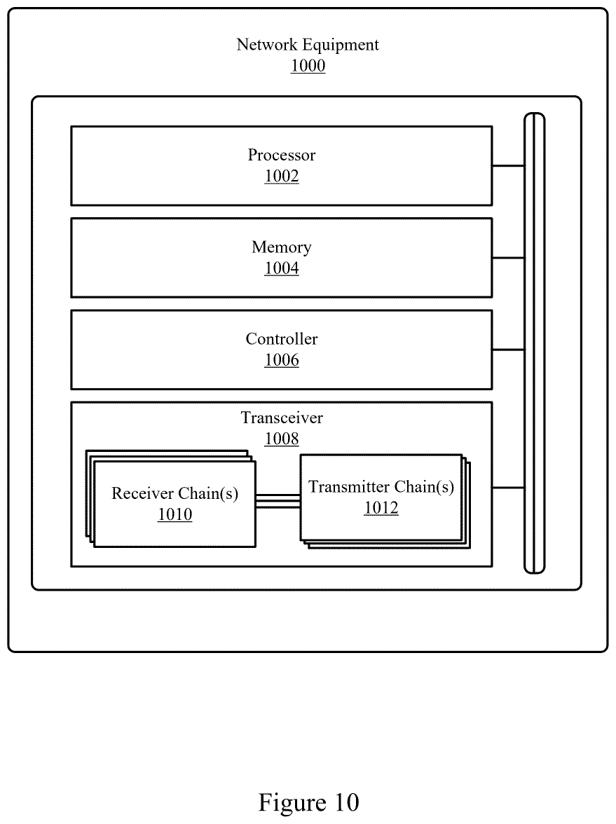

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for receiving, from a UE, first signaling that requests a configuration for collection of data associated with one or more AI functionalities, and transmitting, responsive to the first signaling, second signaling that indicates the configuration for the collection of the data.

Additionally, the NE 1000 may be configured to support any one or combination of the configuration includes respective sets of parameters corresponding to the one or more AI functionalities at the UE. Additionally, or alternatively, the NE 1000 may be configured to support receiving third signaling that indicates information corresponding to a set of AI functionalities supported by the UE, where the set of AI functionalities includes the one or more AI functionalities and transmit fourth signaling that indicates respective information related to one or more parameters corresponding to the one or more AI functionalities at the UE, where the respective information related to the one or more parameters includes at least one of a list of parameters or a time-frequency configuration for the one or more parameters. Additionally, or alternatively, the first signaling indicates one or more of the one or more AI functionalities at the UE, an ID of the one or more AI functionalities at the UE, a respective set of parameters corresponding to the one or more AI functionalities at the UE, or an ID of the respective set of parameters corresponding to the one or more AI functionalities at the UE. Additionally, or alternatively, the NE 1000 may be configured to support transmitting, prior to receiving the first signaling, third signaling that indicates a set of configurations for collection of respective data for a set of AI functionalities, where the set of configurations includes the configuration, the first signaling requests activation of the configuration, and the second signaling activates the configuration. Additionally, or alternatively, the NE 1000 may be configured to support transmitting third signaling that accepts the collection of the data or rejects the collection of the data. Additionally, or alternatively, the NE 1000 may be configured to support transmitting third signaling that indicates associated IDs corresponding to one or more conditions at the NE.

Additionally, or alternatively, the NE 1000 may be configured to support receiving at least one of a status report or a SR that indicates at least one of a presence of the data in a buffer associated with the UE, an availability of the data, an amount of the data in the buffer, a priority level associated with the data, or an ID associated with the one or more AI functionalities at the UE. Additionally, or alternatively, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. Additionally, or alternatively, the configuration includes one or more of measurement quantities associated with the data, time-frequency resources associated with the collection of the data, or metrics associated with the one or more AI functionalities at the UE. Additionally, or alternatively, the NE includes a base station or an LMF. Additionally, or alternatively, the first signaling includes RRC signaling.

The NE 1000 may be configured to or operable to support a means for transmitting first signaling that requests data associated with one or more AI functionalities, and receiving, responsive to the first signaling, second signaling that approves collection of the data or rejects the collection of the data based on a configuration for the collection of the data.

Additionally, the NE 1000 may be configured to support any one or combination of the first signaling is transmitted to at least one of a UE or an additional NE. Additionally, or alternatively, the configuration includes respective sets of parameters corresponding to the one or more AI functionalities, where the one or more AI functionalities are at a UE. Additionally, or alternatively, the one or more AI functionalities includes one or more of a beam management procedure, a CSI prediction procedure, a measurement prediction, or an RLF prediction. Additionally, or alternatively, the first signaling indicates a periodicity for collecting the data. Additionally, or alternatively, the NE includes an OAM entity, a CN, or an OTT server.

Additionally, or alternatively, the NE 1000 may support at least one memory (e.g., the memory 1004) and at least one processor (e.g., the processor 1002) coupled with the at least one memory and configured to cause the NE to receive, from a UE, first signaling that requests a configuration for collection of data associated with one or more AI functionalities, and transmit, responsive to the first signaling, second signaling that indicates the configuration for the collection of the data.

Additionally, the NE 1000 may be configured to support any one or combination of the configuration includes respective sets of parameters corresponding to the one or more AI functionalities at the UE. Additionally, or alternatively, the NE 1000 may be configured to support to receive third signaling that indicates information corresponding to a set of AI functionalities supported by the UE, where the set of AI functionalities includes the one or more AI functionalities and transmit fourth signaling that indicates respective information related to one or more parameters corresponding to the one or more AI functionalities at the UE, where the respective information related to the one or more parameters includes at least one of a list of parameters or a time-frequency configuration for the one or more parameters. Additionally, or alternatively, the first signaling indicates one or more of the one or more AI functionalities at the UE, an ID of the one or more AI functionalities at the UE, a respective set of parameters corresponding to the one or more AI functionalities at the UE, or an ID of the respective set of parameters corresponding to the one or more AI functionalities at the UE. Additionally, or alternatively, the NE 1000 may be configured to support to transmit, prior to receiving the first signaling, third signaling that indicates a set of configurations for collection of respective data for a set of AI functionalities, where the set of configurations includes the configuration, the first signaling requests activation of the configuration, and the second signaling activates the configuration. Additionally, or alternatively, the NE 1000 may be configured to support to transmit third signaling that accepts the collection of the data or rejects the collection of the data. Additionally, or alternatively, the NE 1000 may be configured to support to transmit third signaling that indicates associated IDs corresponding to one or more conditions at the NE.

Additionally, or alternatively, the NE 1000 may be configured to support to receive at least one of a status report or a SR that indicates at least one of a presence of the data in a buffer associated with the UE, an availability of the data, an amount of the data in the buffer, a priority level associated with the data, or an ID associated with the one or more AI functionalities at the UE. Additionally, or alternatively, the first signaling includes a request for at least one of a measurement configuration associated with the data, a logging configuration associated with the data, or a reporting configuration associated with the data, and where the configuration includes the at least one of the measurement configuration associated with the data, the logging configuration associated with the data, or the reporting configuration associated with the data. Additionally, or alternatively, the configuration includes one or more of measurement quantities associated with the data, time-frequency resources associated with the collection of the data, or metrics associated with the one or more AI functionalities at the UE. Additionally, or alternatively, the NE includes a base station or an LMF. Additionally, or alternatively, the first signaling includes RRC signaling.

Additionally, or alternatively, the NE 1000 may support at least one memory (e.g., the memory 1004) and at least one processor (e.g., the processor 1002) coupled with the at least one memory and configured to cause the NE to transmit first signaling that requests data associated with one or more AI functionalities, and receive, responsive to the first signaling, second signaling that approves collection of the data or rejects the collection of the data based on a configuration for the collection of the data.

Additionally, the NE 1000 may be configured to support any one or combination of the first signaling is transmitted to at least one of a UE or an additional NE. Additionally, or alternatively, the configuration includes respective sets of parameters corresponding to the one or more AI functionalities, where the one or more AI functionalities are at a UE. Additionally, or alternatively, the one or more AI functionalities includes one or more of a beam management procedure, a CSI prediction procedure, a measurement prediction, or an RLF prediction. Additionally, or alternatively, the first signaling indicates a periodicity for collecting the data. Additionally, or alternatively, the NE includes an OAM entity, a CN, or an OTT server.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

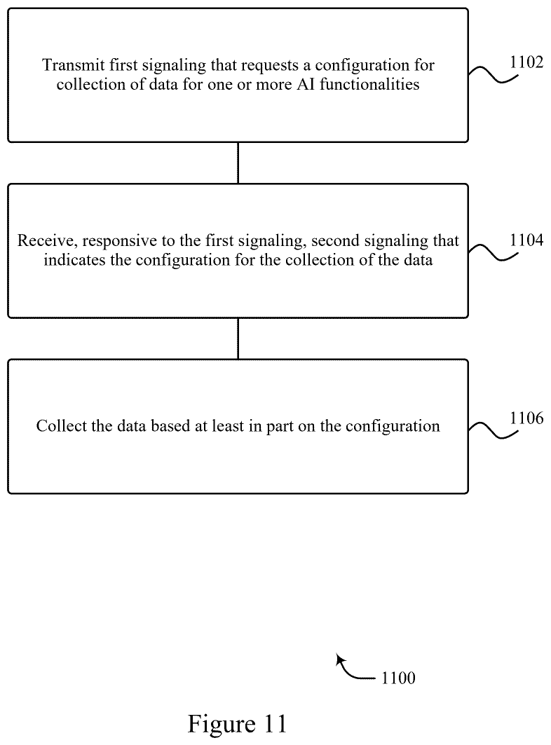

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include transmitting first signaling that requests a configuration for collection of data for one or more AI functionalities. The operations of 1102 may be performed in accordance with examples as described herein. In some implementations, aspects of the operations of 1102 may be performed by a UE as described with reference to FIG. 8.

At 1104, the method may include receiving, responsive to the first signaling, second signaling that indicates the configuration for the collection of the data. The operations of 1104 may be performed in accordance with examples as described herein. In some implementations, aspects of the operations of 1104 may be performed by a UE as described with reference to FIG. 8.

At 1106, the method may include collecting the data based at least in part on the configuration. The operations of 1106 may be performed in accordance with examples as described herein. In some implementations, aspects of the operations of 1106 may be performed a UE as described with reference to FIG. 8.

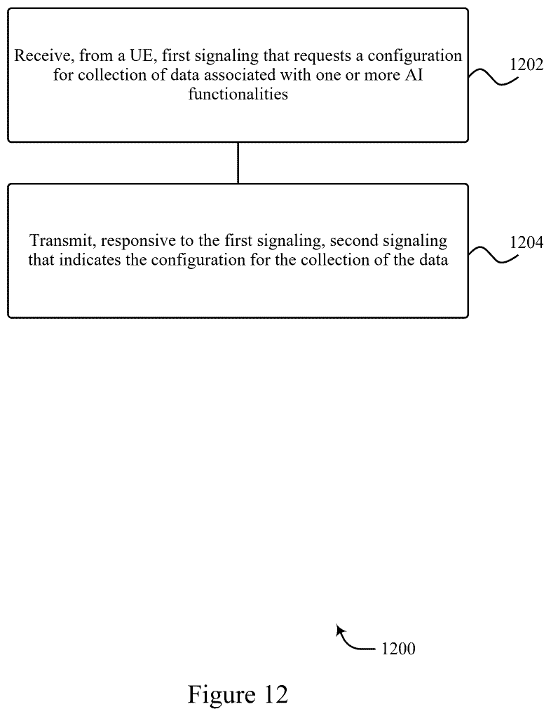

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include receiving, from a UE, first signaling that requests a configuration for collection of data associated with one or more AI functionalities. The operations of 1202 may be performed in accordance with examples as described herein. In some implementations, aspects of the operations of 1202 may be performed by a NE as described with reference to FIG. 10.

At 1204, the method may include transmitting, responsive to the first signaling, second signaling that indicates the configuration for the collection of the data. The operations of 1204 may be performed in accordance with examples as described herein. In some implementations, aspects of the operations of 1204 may be performed by a NE as described with reference to FIG. 10.

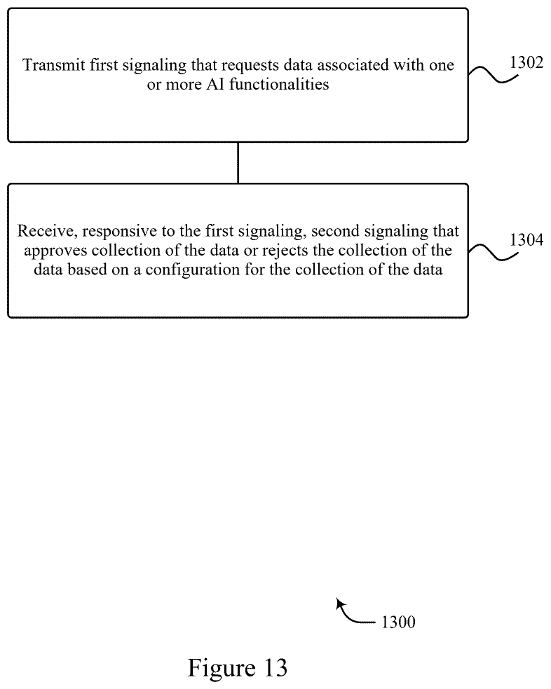

FIG. 13 illustrates a flowchart of a method 1300 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include transmitting by a NE (e.g., or transmitting from a training entity) first signaling that requests data associated with one or more AI functionalities. The operations of 1302 may be performed in accordance with examples as described herein. In some implementations, aspects of the operations of 1302 may be performed by a NE as described with reference to FIG. 10.

At 1304, the method may include receiving from a NE (e.g., or receiving by a training entity), responsive to the first signaling, second signaling that approves collection of the data or rejects the collection of the data based on a configuration for the collection of the data. The operations of 1304 may be performed in accordance with examples as described herein. In some implementations, aspects of the operations of 1304 may be performed by a NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit first signaling that requests a configuration for collection of data for one or more artificial intelligence (AI) functionalities;
receive, responsive to the first signaling, second signaling that indicates the configuration for the collection of the data; and
collect the data based at least in part on the configuration.

2. The UE of claim 1, wherein the configuration comprises respective sets of parameters corresponding to the one or more AI functionalities, and wherein the one or more AI functionalities are performed or performable by the UE.

3. The UE of claim 2, wherein the at least one processor is further configured to cause the UE to perform a handshake procedure with a network equipment (NE) prior to collection of the data.

4. The UE of claim 1, wherein the at least one processor is further configured to cause the UE to:
transmit third signaling that indicates information corresponding to a plurality of AI functionalities supported by the UE, wherein the plurality of AI functionalities comprises the one or more AI functionalities; and
receive fourth signaling that indicates respective information related to one or more parameters corresponding to the one or more AI functionalities at the UE, wherein the respective information related to the one or more parameters comprises at least one of a set of parameters or a time-frequency configuration for the one or more parameters.

5. The UE of claim 1, wherein the first signaling indicates one or more of the one or more AI functionalities performed or performable by the UE, an identifier of the one or more AI functionalities performed or performable by the UE, a respective set of parameters corresponding to the one or more AI functionalities performed or performable by the UE, or an identifier of the respective set of parameters corresponding to the one or more AI functionalities performed or performable by the UE.

6. The UE of claim 1, wherein the at least one processor is further configured to cause the UE to receive, prior to the first signaling, third signaling that indicates a plurality of configurations for collection of respective data for a plurality of AI functionalities, wherein:
the plurality of configurations comprises the configuration;
the first signaling requests activation of the configuration; and
the second signaling activates the configuration.

7. The UE of claim 1, wherein the one or more AI functionalities comprise one or more of a beam management procedure, a channel state information (CSI) prediction procedure, a measurement prediction, or a radio link failure (RLF) prediction.

8. The UE of claim 1, wherein the at least one processor is further configured to cause the UE to receive third signaling that indicates associated identifiers corresponding to one or more network conditions.

9. The UE of claim 1, wherein the at least one processor is further configured to cause the UE to transmit third signaling that accepts the collection of the data or rejects the collection of the data.

10. The UE of claim 1, wherein the at least one processor is further configured to cause the UE to transmit third signaling that indicates information for initiating or terminating data collection, or indicates assistance information for the data collection.

11. The UE of claim 1, wherein the at least one processor is further configured to cause the UE to receive third signaling that requests the data, wherein the third signaling indicates a periodicity for collecting the data.

12. The UE of claim 1, wherein the at least one processor is further configured to cause the UE to transmit at least one of a status report or a scheduling request that indicates at least one of a presence of the data in a buffer associated with the UE, an availability of the data, an amount of the data in the buffer, a priority level associated with the data, or an identifier associated with the one or more AI functionalities.

13. The UE of claim 1, wherein the first signaling comprises a request for at least one of a measurement configuration associated with the data, a logging configuration associated with the data, and a reporting configuration associated with the data.

14. The UE of claim 1, wherein the configuration comprises one or more of measurement quantities associated with the data, time-frequency resources associated with the collection of the data, or metrics associated with the one or more AI functionalities.

15. The UE of claim 1, wherein the first signaling comprises radio resource control (RRC) signaling.

16. A processor for wireless communication, comprising:
at least one controller coupled with at least one memory and configured to cause the processor to:
transmit first signaling that requests a configuration for collection of data for one or more artificial intelligence (AI) functionalities;
receive, responsive to the first signaling, second signaling that indicates the configuration for the collection of the data; and
collect the data based at least in part on the configuration.

17. A network equipment (NE) for wireless communication, comprising:
at least one memory; and
at least one processor coupled with the at least one memory and configured to cause the NE to:
receive, from a user equipment (UE), first signaling that requests a configuration for collection of data associated with one or more artificial intelligence (AI) functionalities; and
transmit, responsive to the first signaling, second signaling that indicates the configuration for the collection of the data.

18. The NE of claim 17, wherein the at least one processor is further configured to cause the NE to transmit third signaling that accepts the collection of the data or rejects the collection of the data.

19. The NE of claim 17, wherein the at least one processor is further configured to cause the NE to transmit third signaling that indicates associated identifiers corresponding to one or more conditions at the NE.

20. A network equipment (NE) for wireless communication, comprising:
at least one memory; and
at least one processor coupled with the at least one memory and configured to cause the NE to:
transmit first signaling that requests data associated with one or more artificial intelligence (AI) functionalities; and
receive, responsive to the first signaling, second signaling that approves collection of the data or rejects the collection of the data based at least in part on a configuration for the collection of the data.
